(19) United States
(12) Patent Application Publication
(10) Pub. No.: US 2004/0235523 A1
(43) Pub. Date: Nov. 25, 2004

(54) System for replicating data of a mobile station

(76) Inventors: Michael Anton Schrire, Stoney (AU); Paul Sellers, London (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/471,183

(22) PCT Filed: Mar. 6, 2002
(86) PCT No.: PCT/GB02/01022

(30) Foreign Application Priority Data
Mar. 7, 2001 (GB) 0105646.4
Sep. 19, 2001 (GB) 0122598.6

(51) Int. Cl. H04M 1/00

(52) U.S. Cl. 455/558; 455/550.1

(57) ABSTRACT

A data storage system suitable for storing data in the SIM card of a mobile station is described. On amending the data, an SMS or Internet message containing the amended data is transmitted to a remote data storage system for storage.

This invention relates to data storage systems. The invention has particular, although not exclusive, relevance to the backup of data stored on a SIM (Subscriber Identification Module) card in a mobile phone.

A SIM card is a detachable module for a mobile phone, the SIM card being owned by the network operator of a mobile phone communication system and including data specific to the network operator together with data entered by and specific to the user, such as an address book storing abbreviated dialling numbers. When a user decides to obtain a new mobile phone, so as to obtain further facilities for example, the SIM card is removed from the original mobile phone and inserted in the new phone, thus enabling data entered on the SIM card to be used in the new mobile phone. The problem arises that where the SIM card is lost, due to for example loss or theft of the mobile phone, the data recorded on the SIM card will also be lost at considerable inconvenience to the user. Furthermore accidental deletion or corruption of the data recorded on the SIM card is also possible.

It is an object of the present invention to provide a data backup system in which this problem may be overcome.

According to a first aspect of the present invention, there is provided a data storage,system for use in a data backup system for backing up in a remote database system, data stored in a plurality of data storage systems, the data storage system comprising: means for updating data stored in the data storage system; means for producing a data message including a copy of the updated data; and means for wirelessly transmitting said copied data to said remote data storage system for storage.

In a preferred system, the updated data at each data storage means is automatically wirelessly transmitted to the remote database system.

According to a second aspect of the present invention, there is provided a database system for use in a database backup system for backing up at a database system data stored in a plurality of data storage systems remote from the database system comprising: means for receiving data wirelessly transmitted from each of the plurality of remote data storage systems on update of the information stored in each data storage system; and means for storing said received data.

In one particular application, the data is for use in a billing system.

In a further particular application, the data is for use in a predictive usage system. In yet a further particular application, the data is for use in a fraudulent use surveillance system.

According to a third aspect of the present invention, there is provided a method of updating one of a plurality of databases in which, after entry of the data into the database, backup data is wirelessly transmitted to a remote database effective to store backup data for each of said plurality of databases.

A number of embodiments of the present invention will now be described by way of example only with reference to the accompanying drawings in which:

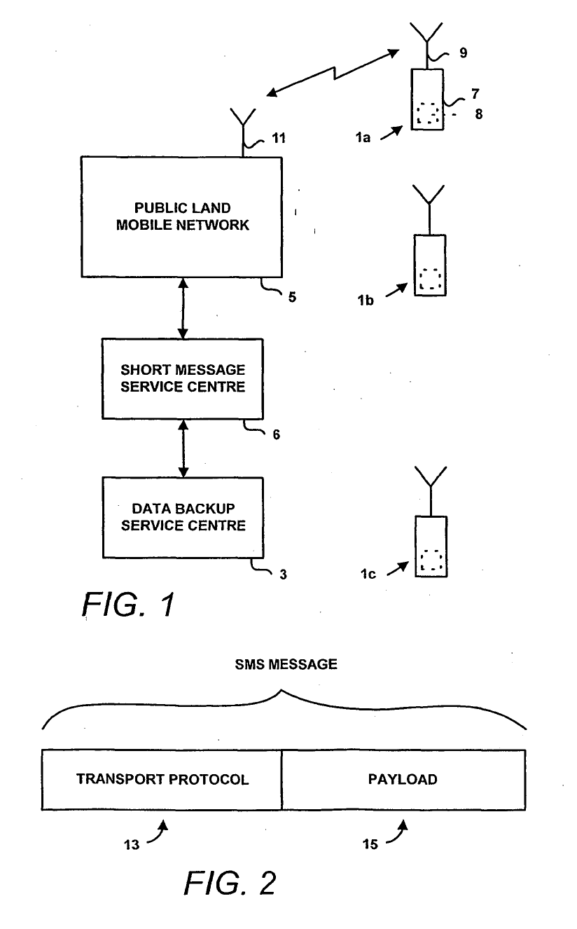

FIG. 1 is an overview of an embodiment of a data backup system communicating via a cellular radio communication system;

FIG. 2 illustrates the data structure of a message conveying backup information between the mobile station and the data backup service centre of FIG. 1;

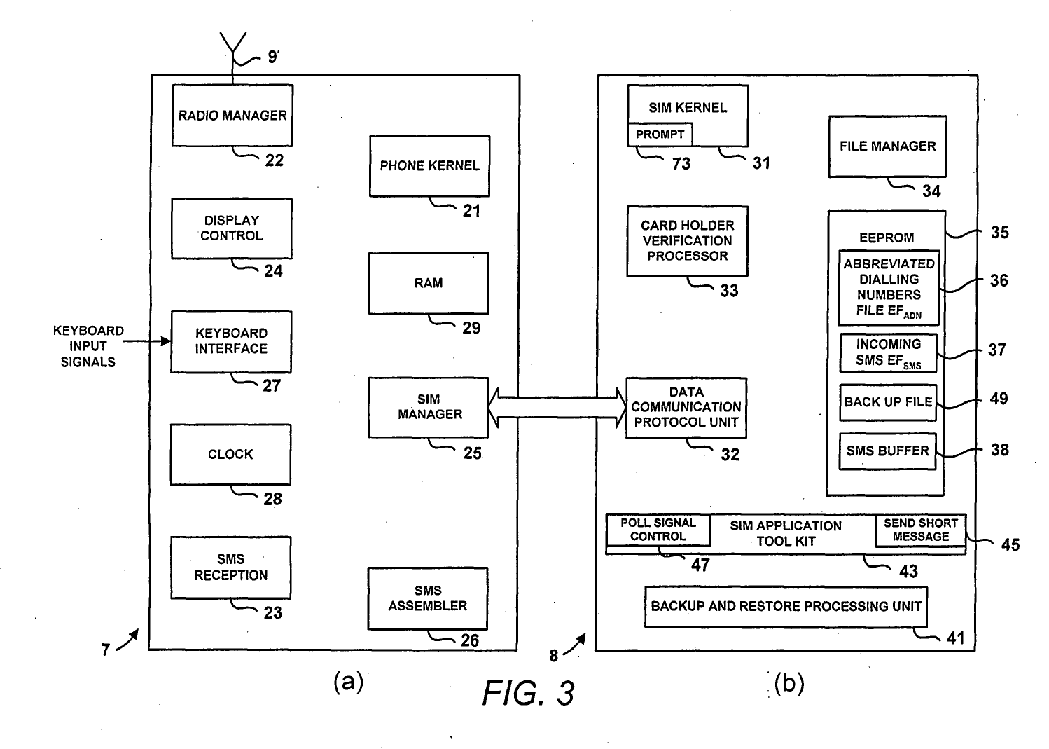

FIG. 3(a) is a schematic illustration of functional modules of software and hardware incorporated in the mobile phone of FIG. 1;

FIG. 3(b) is a schematic illustration of functional modules of software and hardware incorporated in the SIM card of FIG. 1;

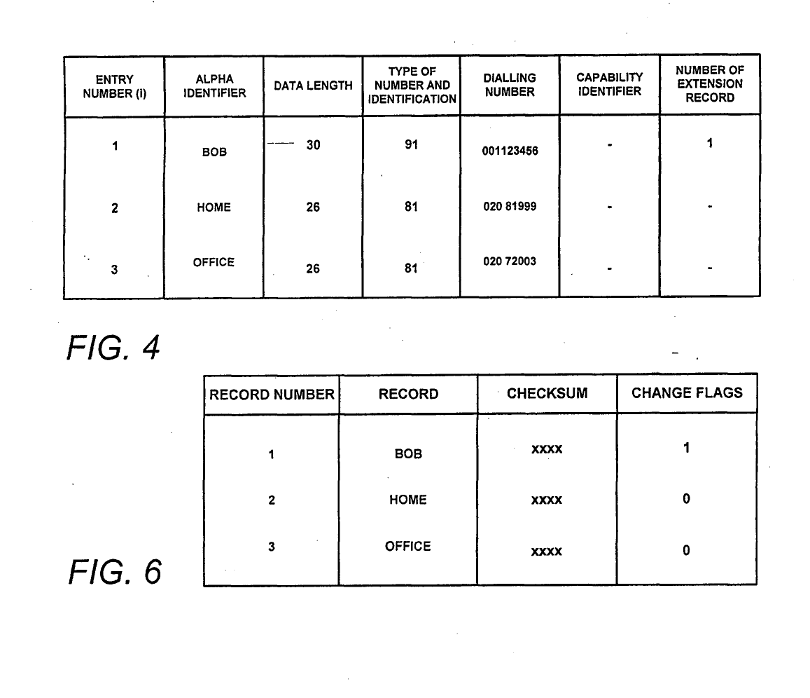

FIG. 4 illustrates the file structure of the abbreviated dialling code file stored in the SIM card of FIG. 3(b);

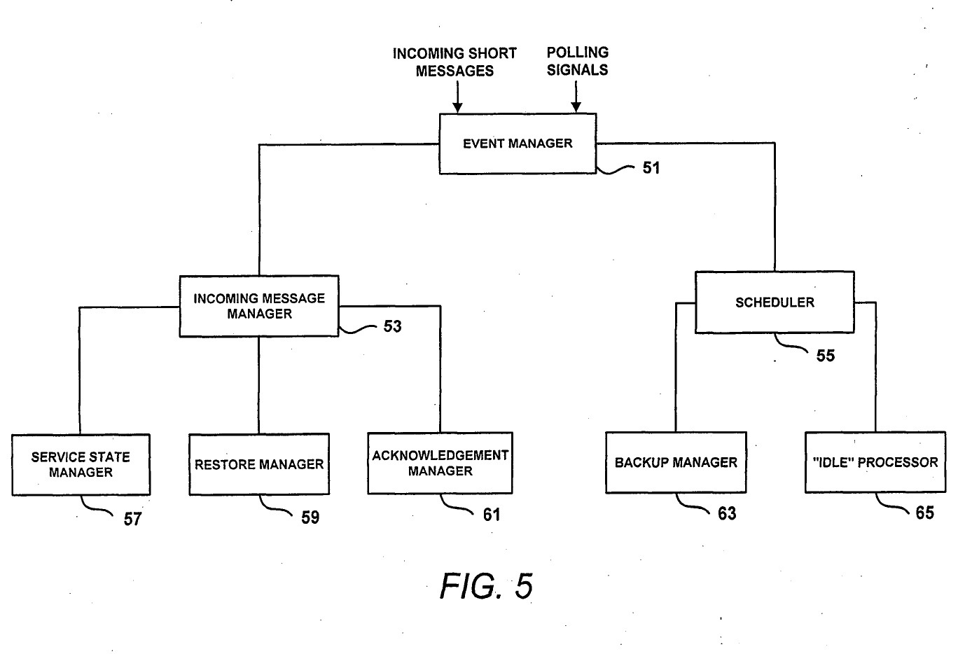

FIG. 5 is a schematic illustration of the functional modules of the backup and restore processing unit incorporated in the SIM card of FIG. 1;

FIG. 6 illustrates the file structure of the data file used in the backup system;

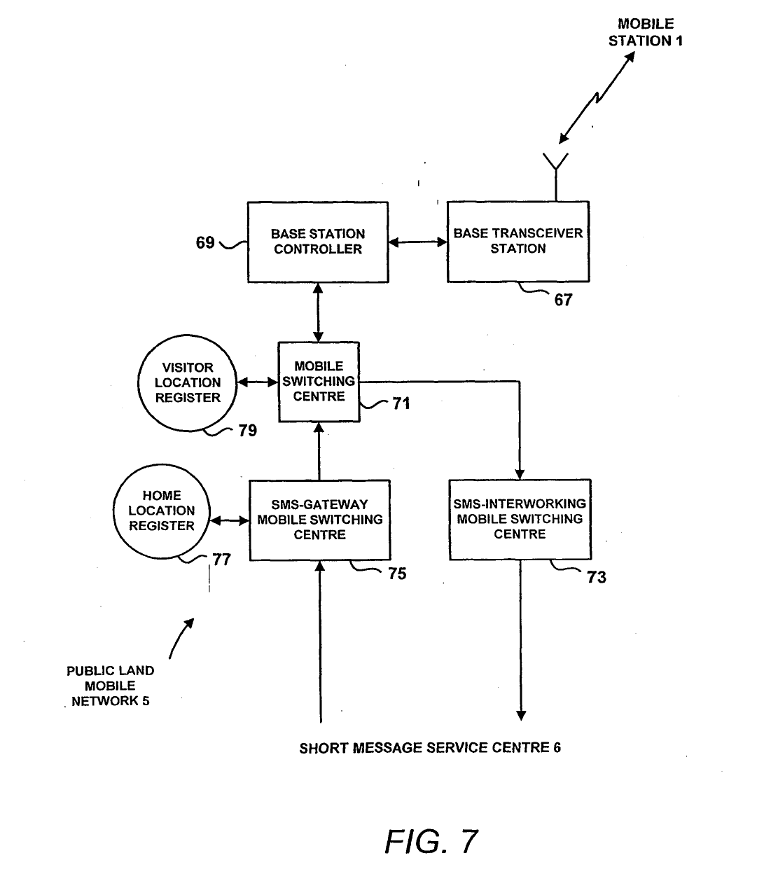

FIG. 7 illustrates schematically parts of the public land mobile network of FIG. 1 relevant to the operation of the data backup service;

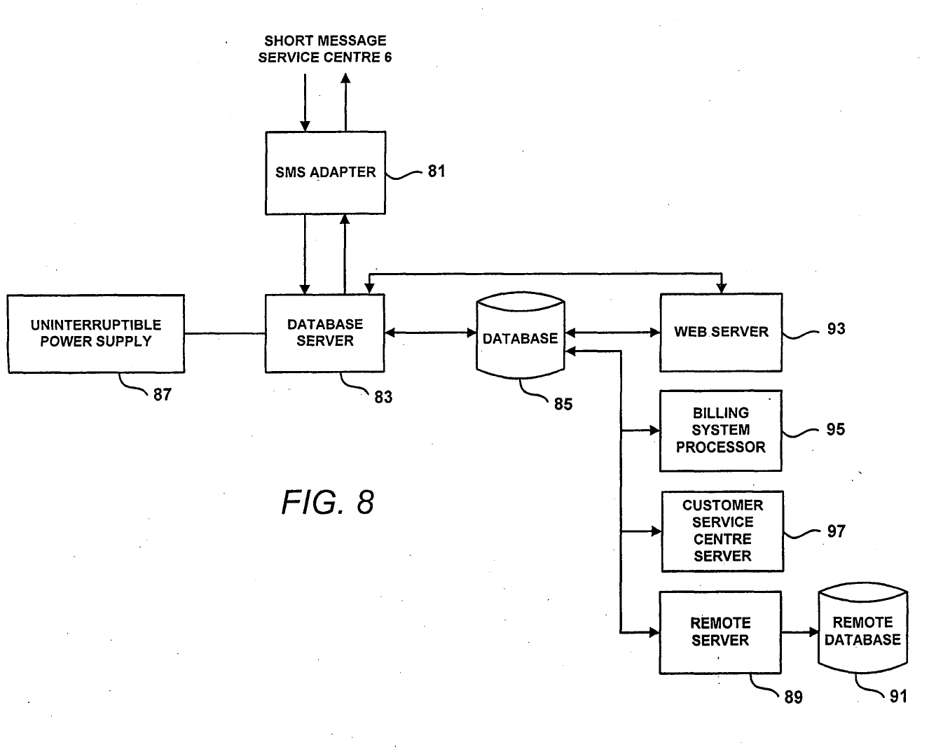

FIG. 8 is a schematic diagram of the architecture of the data backup service centre of FIG. 1;

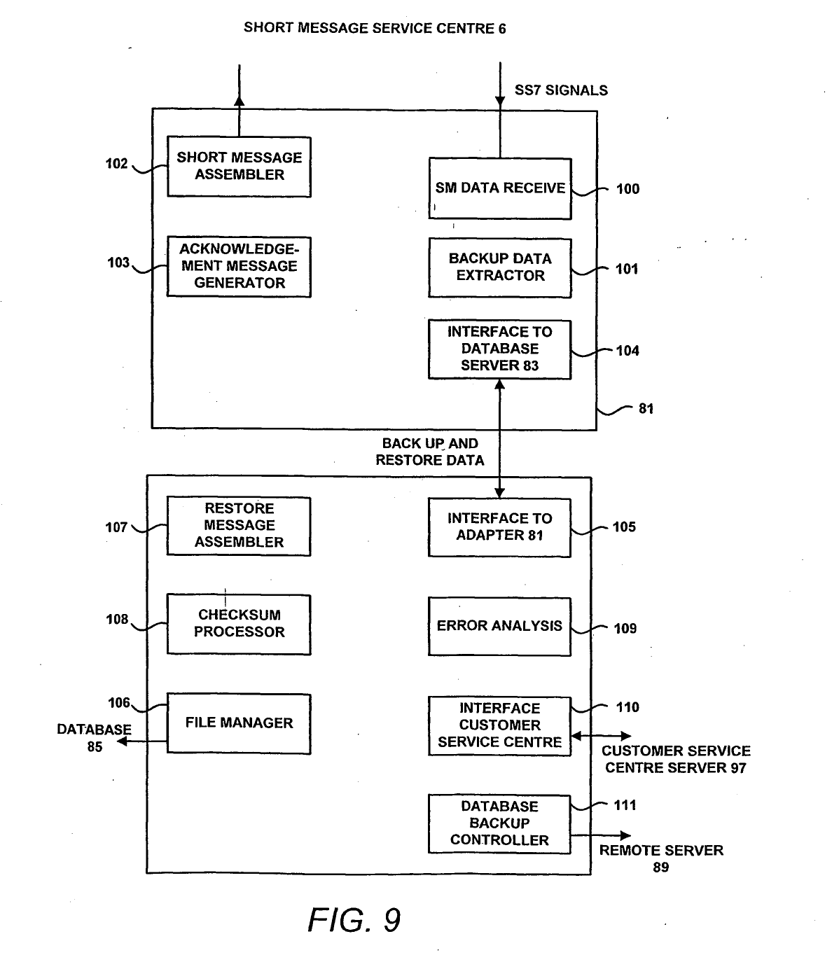

FIG. 9 is a schematic illustration of functional modules of software and hardware incorporated in the data backup service centre of FIG. 1;

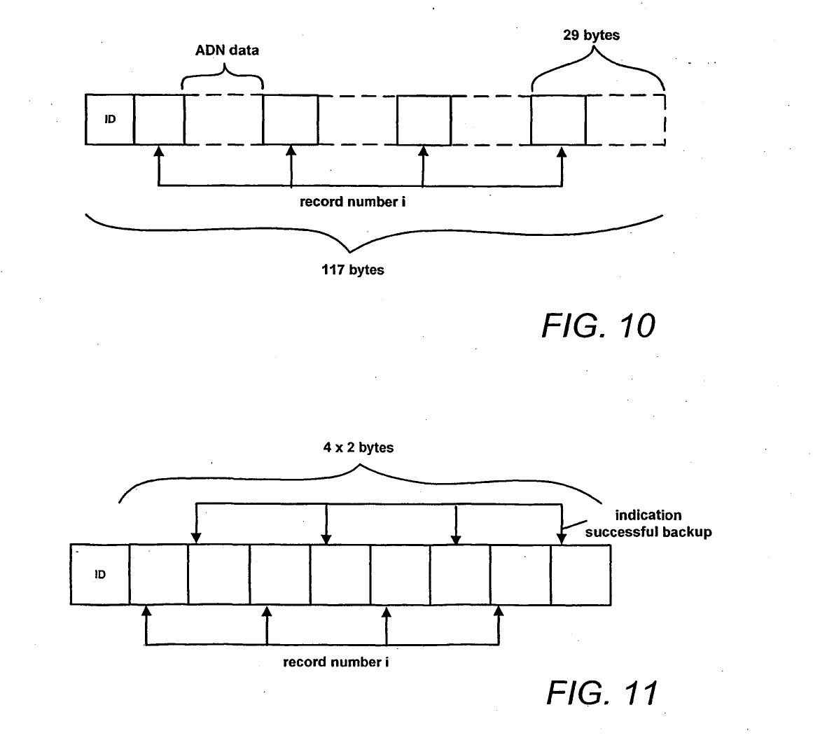

FIG. 10 illustrates the data structure of a backup or restore data message;

FIG. 11 illustrates the data structure of an acknowledgement data message;

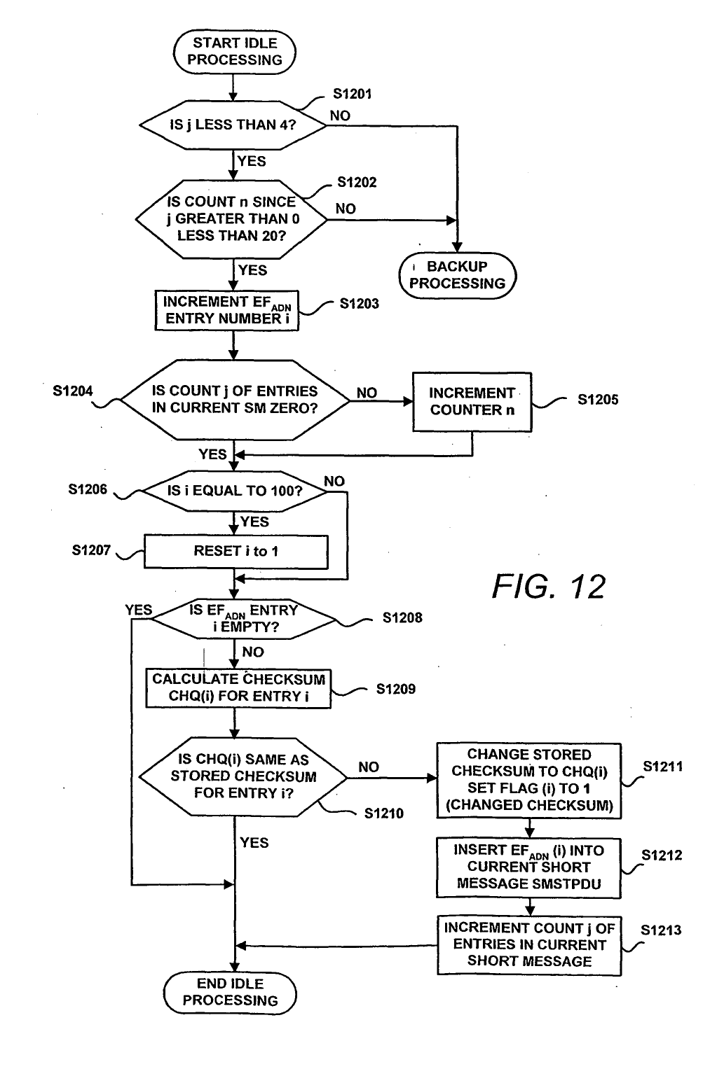

FIG. 12 illustrates the processing procedure for monitoring the file to be backed up.

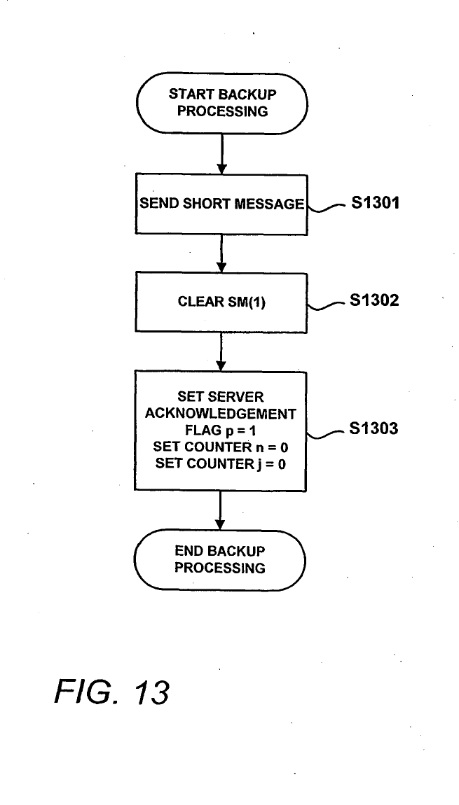

FIG. 13 illustrates process steps carried out when a user updates the abbreviated dialling code file stored in the SIM card of FIG. 3(b);

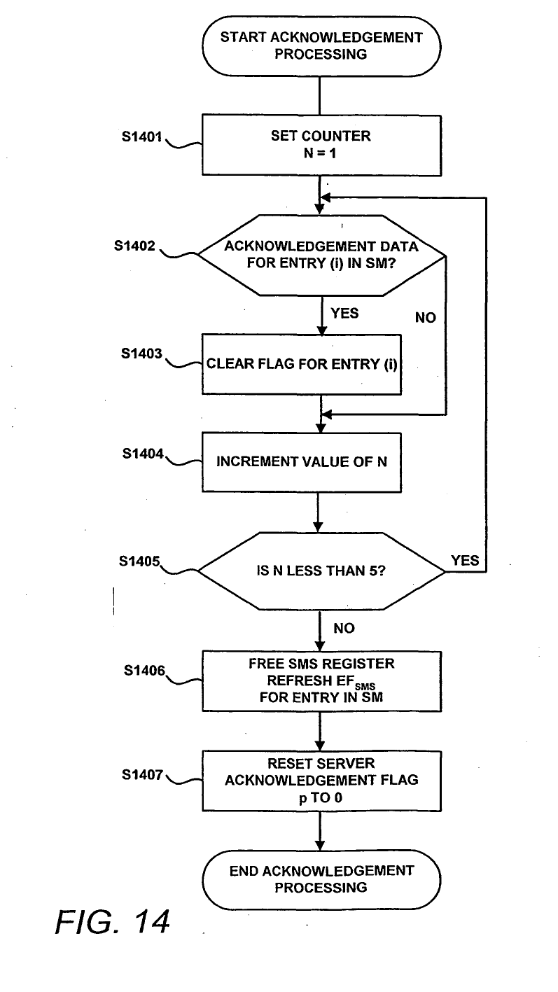

FIG. 14 illustrates the process steps performed at the SIM card on receipt of an “Acknowledgement” message;

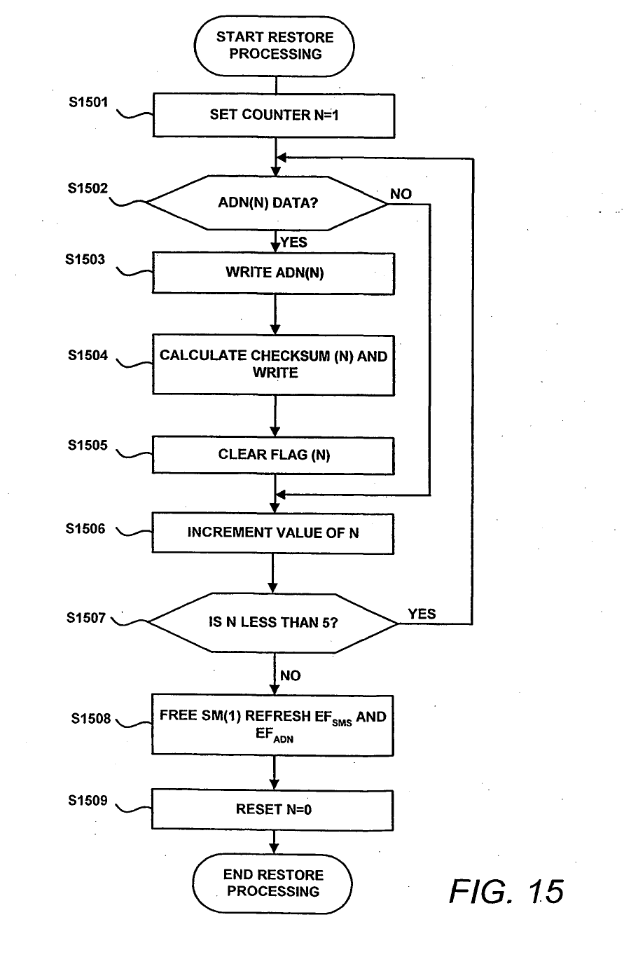

FIG. 15 illustrates the process steps performed at the SIM card on receipt of a “Restore” message;

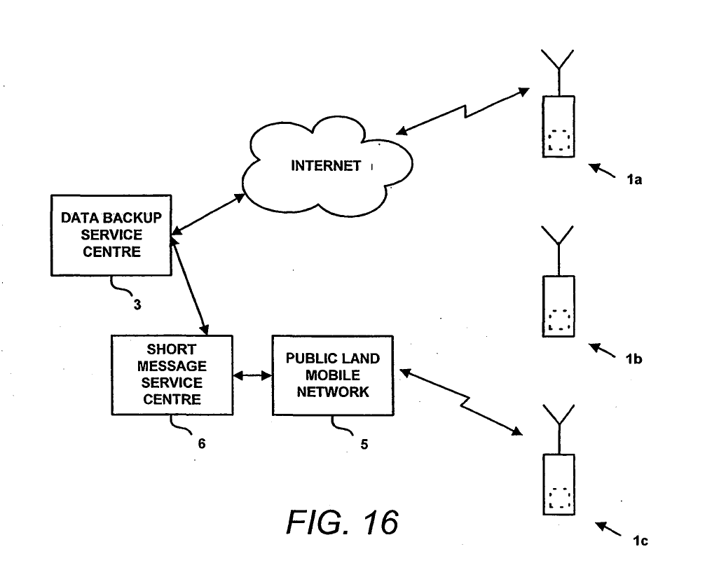

FIG. 16 is an overview of an embodiment of a data backup system communicating via either the Internet or via a cellular radio communication system.

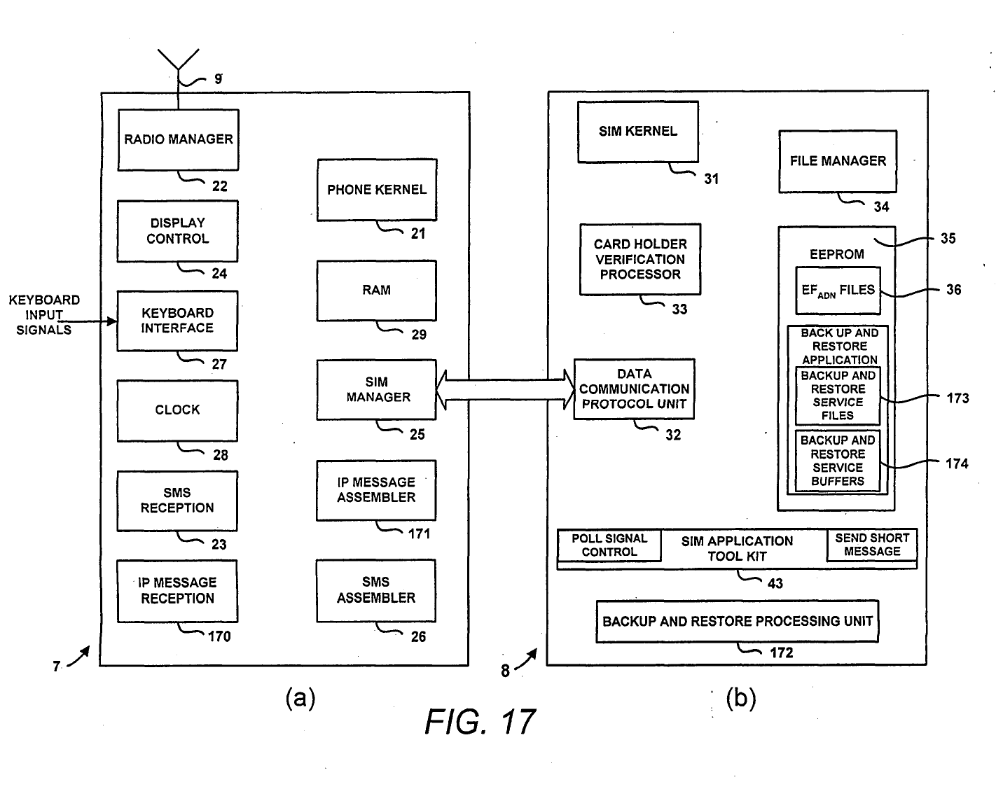

FIG. 17(a) is a schematic illustration of the functional modules of software and hardware incorporated in the mobile phone of the second embodiment of the invention;

FIG. 17(b) is a schematic illustration of the functional modules of software and hardware incorporated in the SIM card of the second embodiment of the invention;

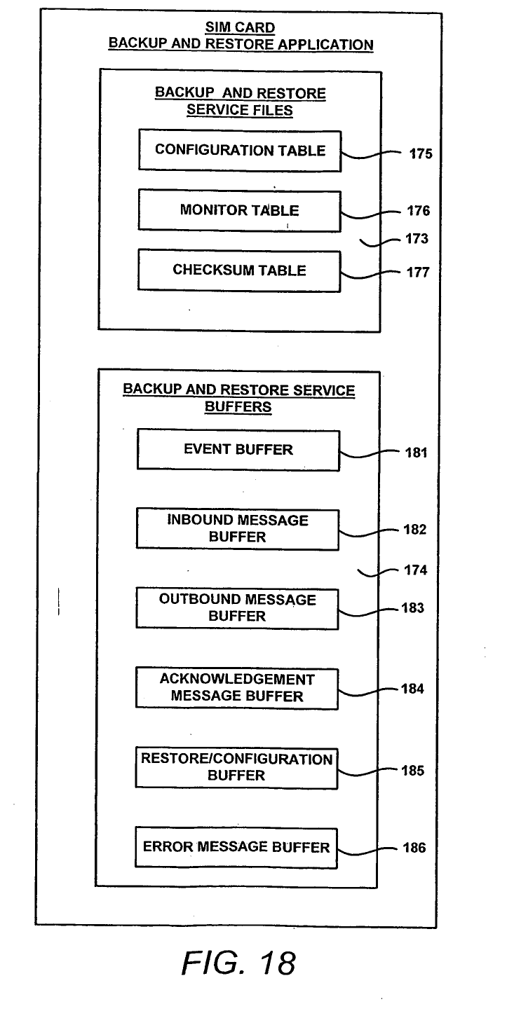

FIG. 18 illustrates the files and buffers of the backup and restore application stored on the SIM card of FIG. 17(b);

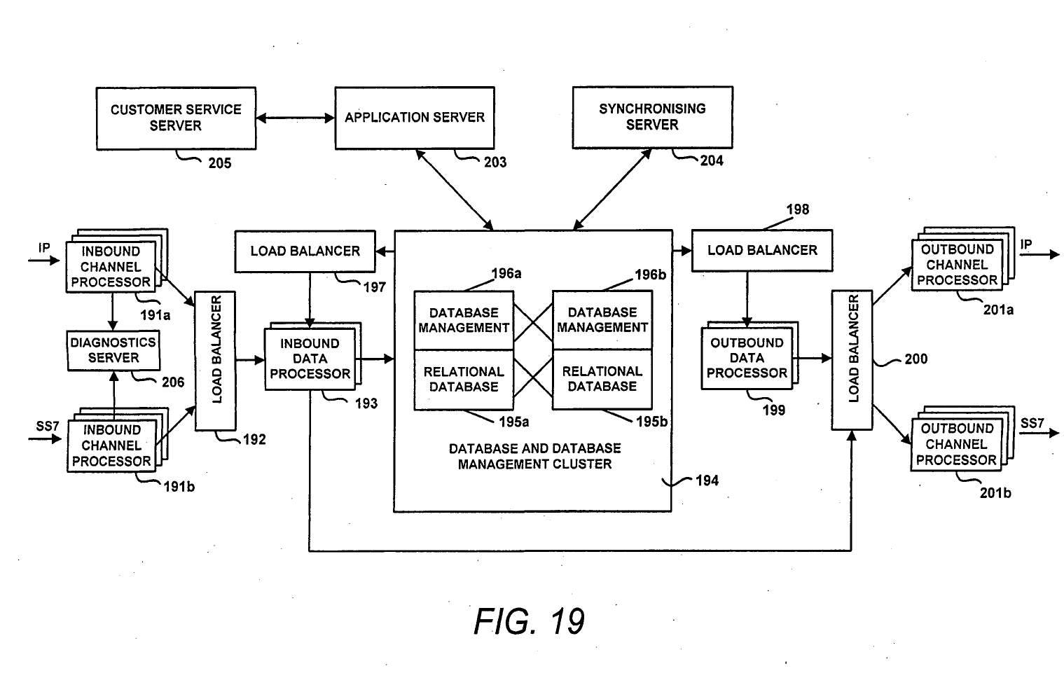

FIG. 19 is a schematic illustration of the functional modules of software and hardware incorporated in the data backup service centre of the second embodiment of the invention;

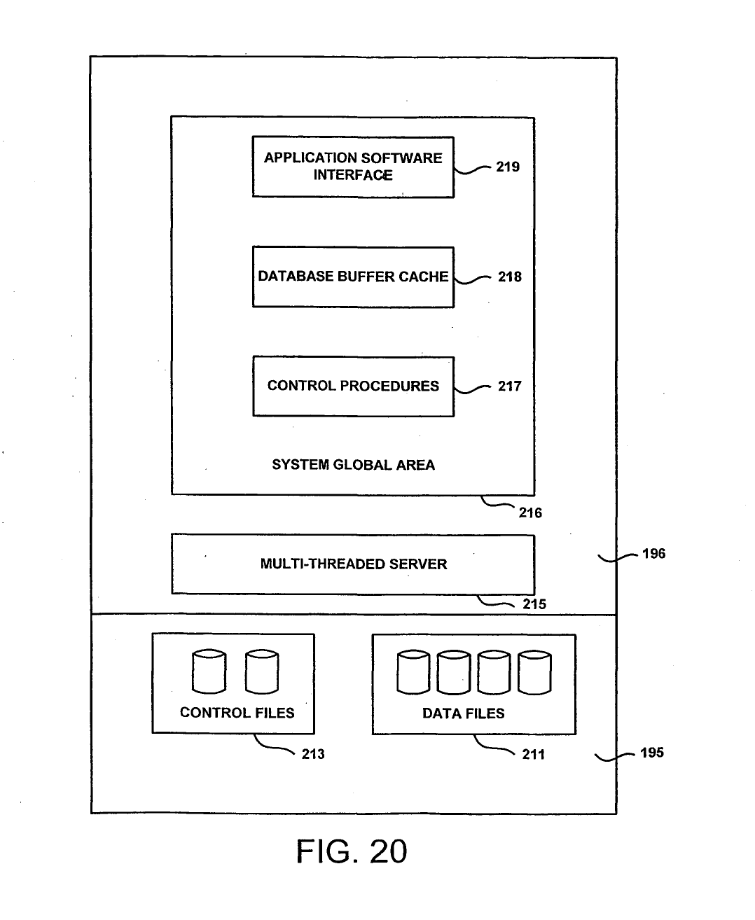

FIG. 20 illustrates schematically the database management and relational database system incorporated in the database backup service centre of FIG. 19;

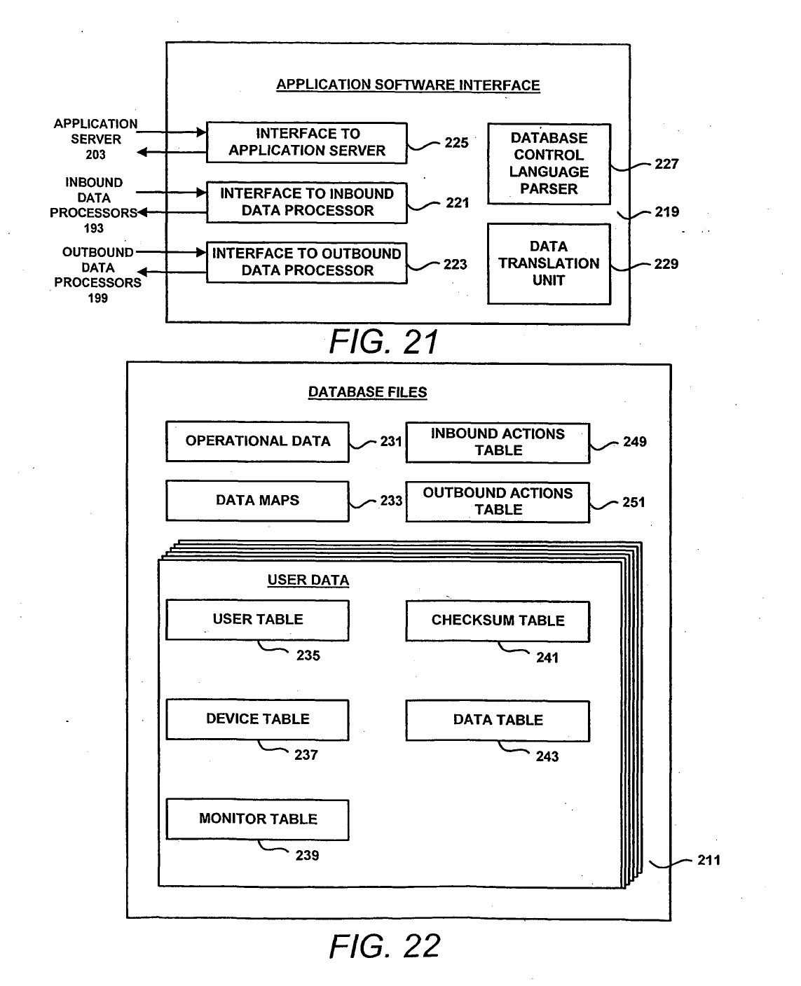

FIG. 21 illustrates the application interface software module incorporated in the database management system of FIG. 20;

FIG. 22 illustrates the database files incorporated in the relational database system of FIG. 20;

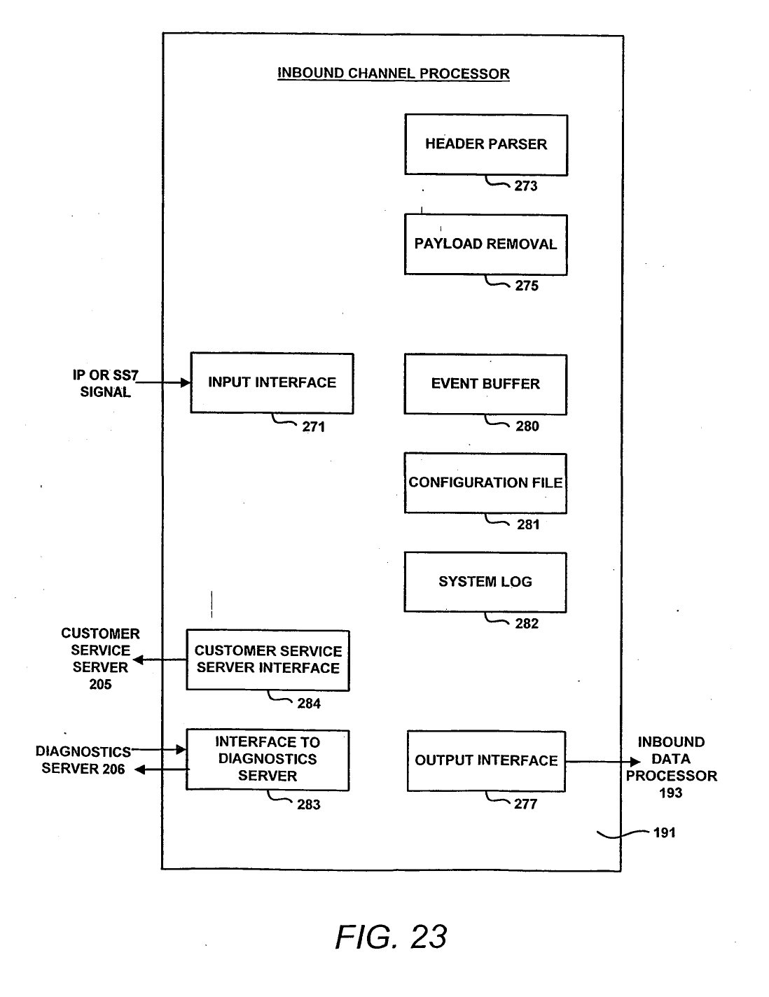

FIG. 23 is a schematic illustration of the functional modules of software and hardware incorporated in the inbound channel processor in the data backup service. centre of FIG. 19;

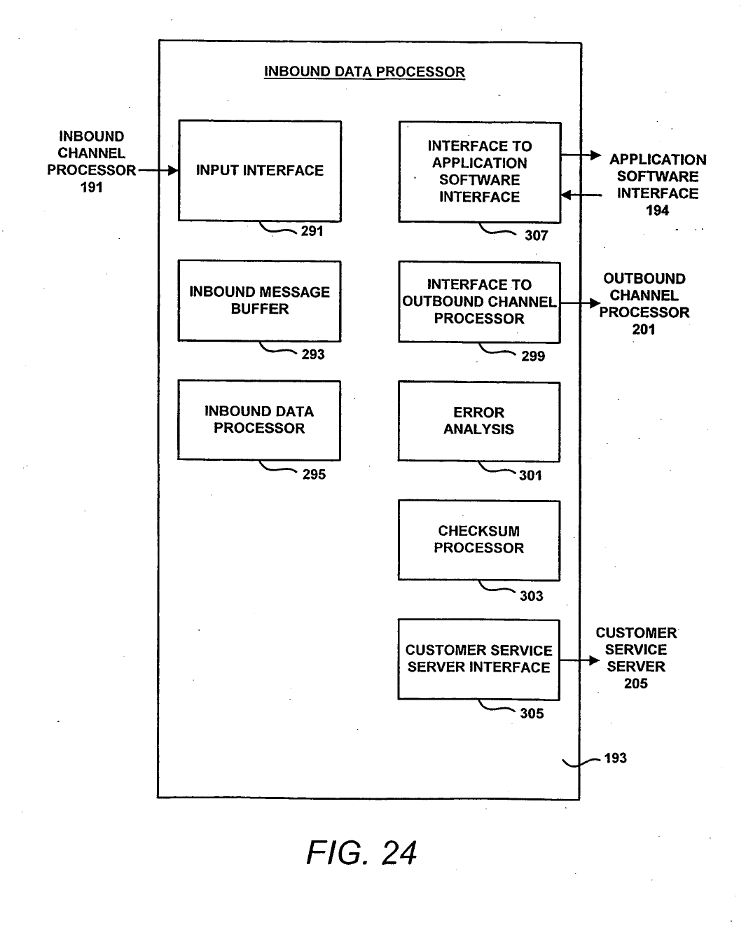

FIG. 24 is a schematic illustration of the functional modules of software and hardware incorporated in the inbound data processor in the data backup service centre of FIG. 19;

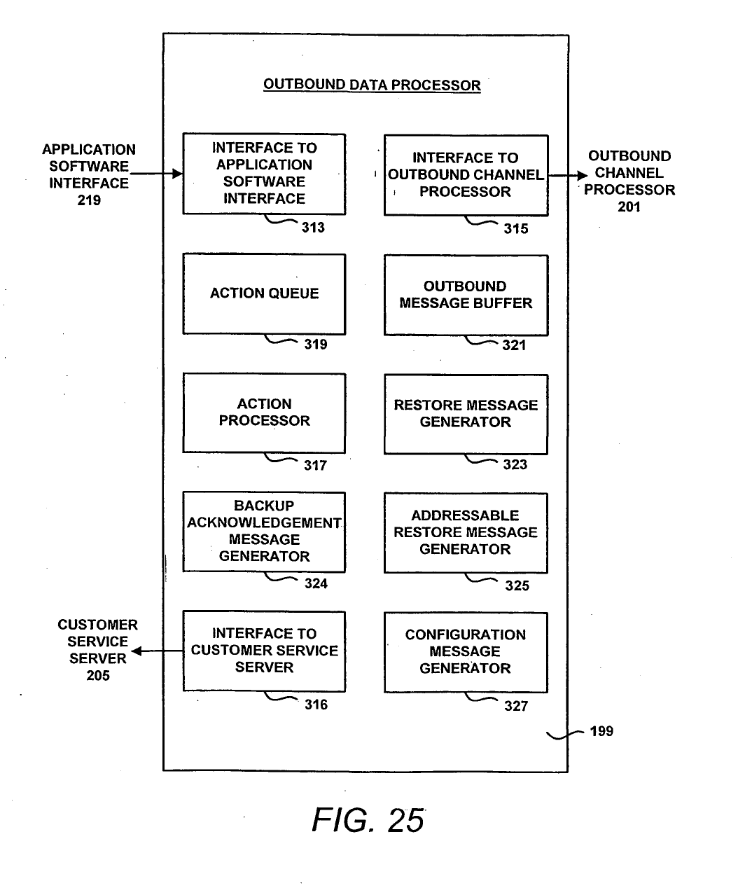

FIG. 25 is a schematic illustration of the functional modules of software and hardware incorporated in the outbound data processor in the data backup service centre of FIG. 19;

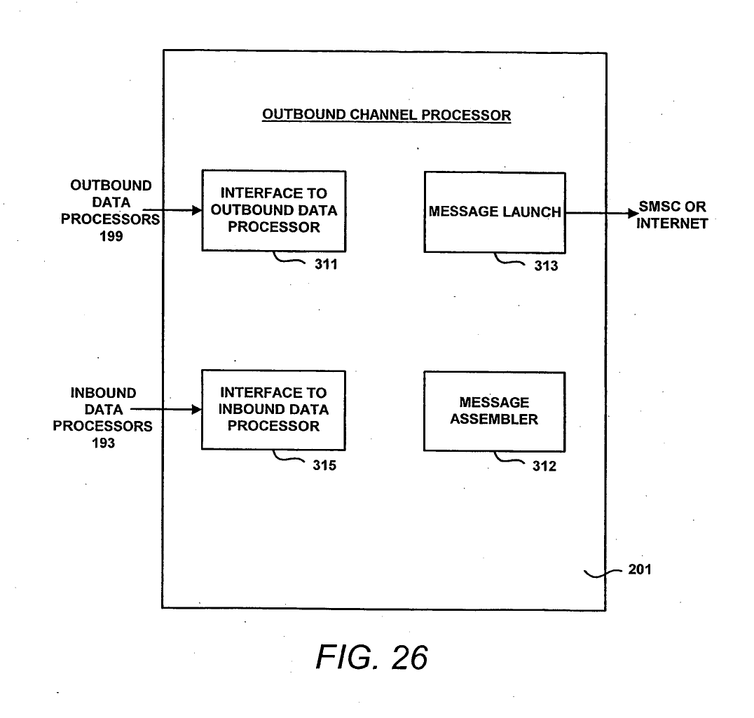

FIG. 26 is a schematic illustration of the functional modules of software and hardware incorporated in the outbound channel processor in the data backup service centre of FIG. 19;

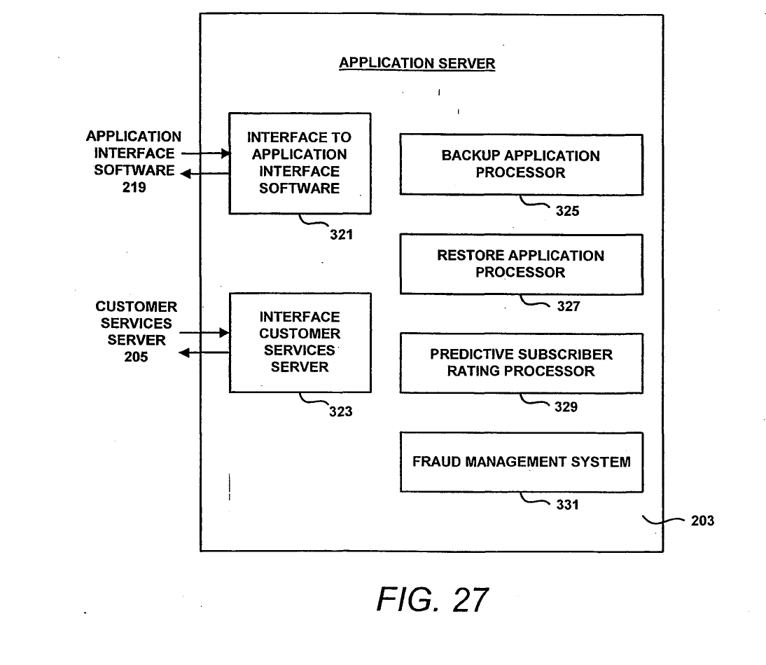

FIG. 27 is a schematic diagram of the functional modules of software and hardware incorporated in the application server in the data backup service centre of FIG. 19;

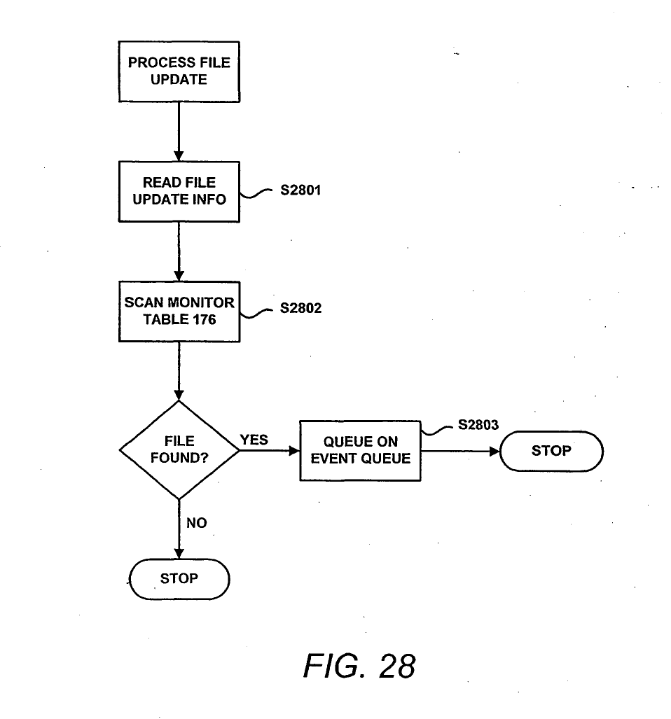

FIG. 28 illustrates the process steps performed at the SIM card of FIG. 17(b) during a file update;

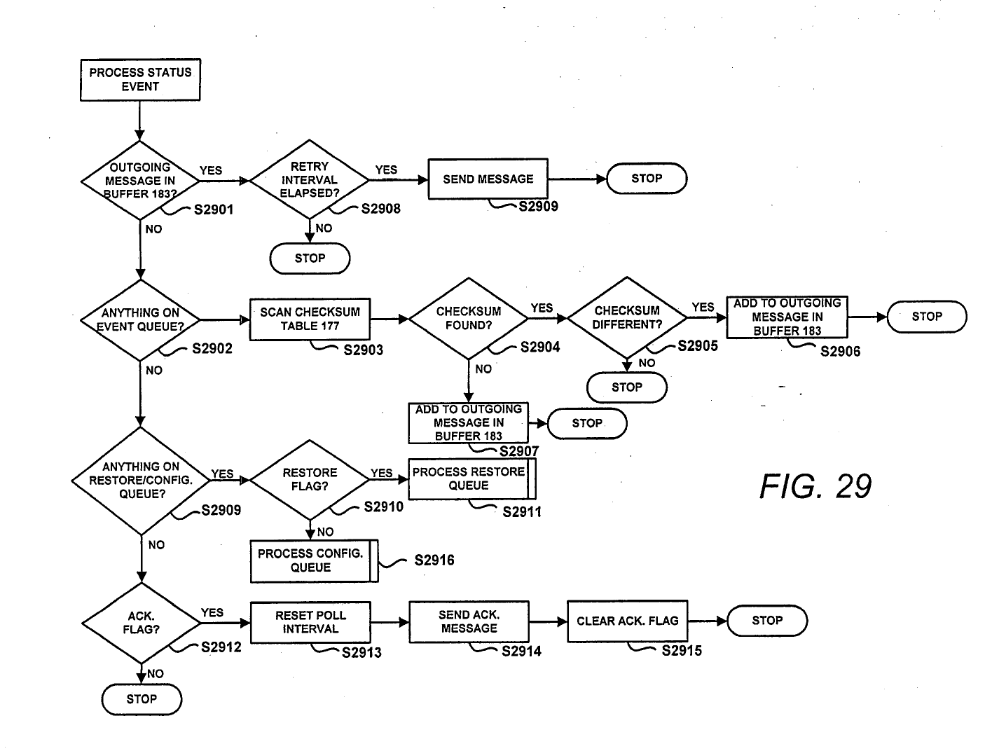

FIG. 29 illustrates the process steps carried out at the SIM card of FIG. 17(b) on the reception of a status event signal;

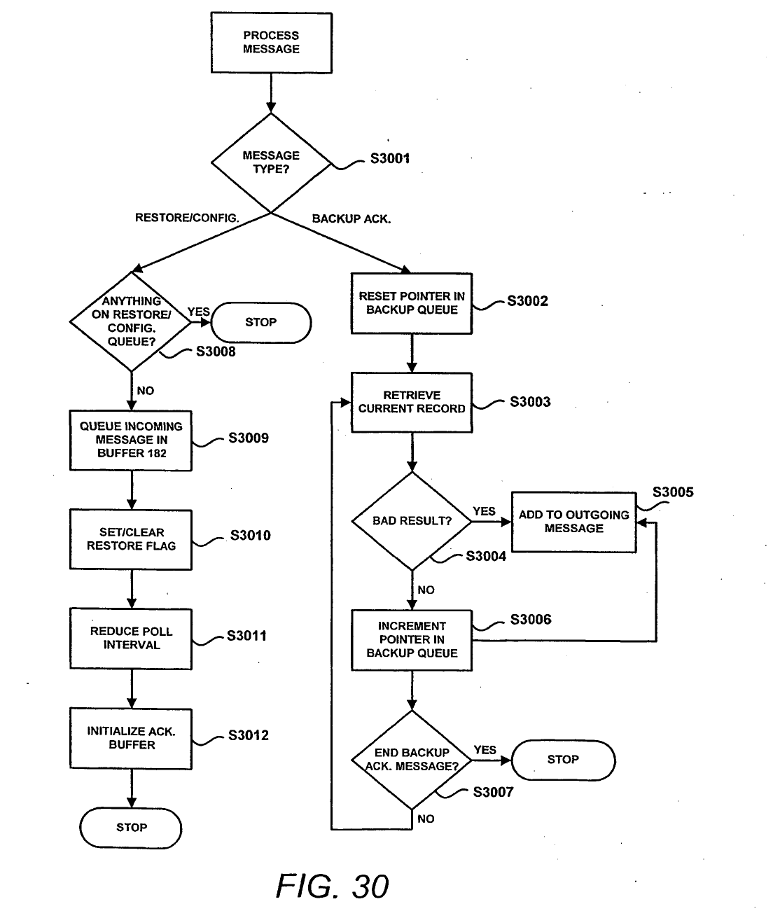

FIG. 30 illustrates the process steps performed at the SIM card of FIG. 17(b) on receipt of an incoming message;

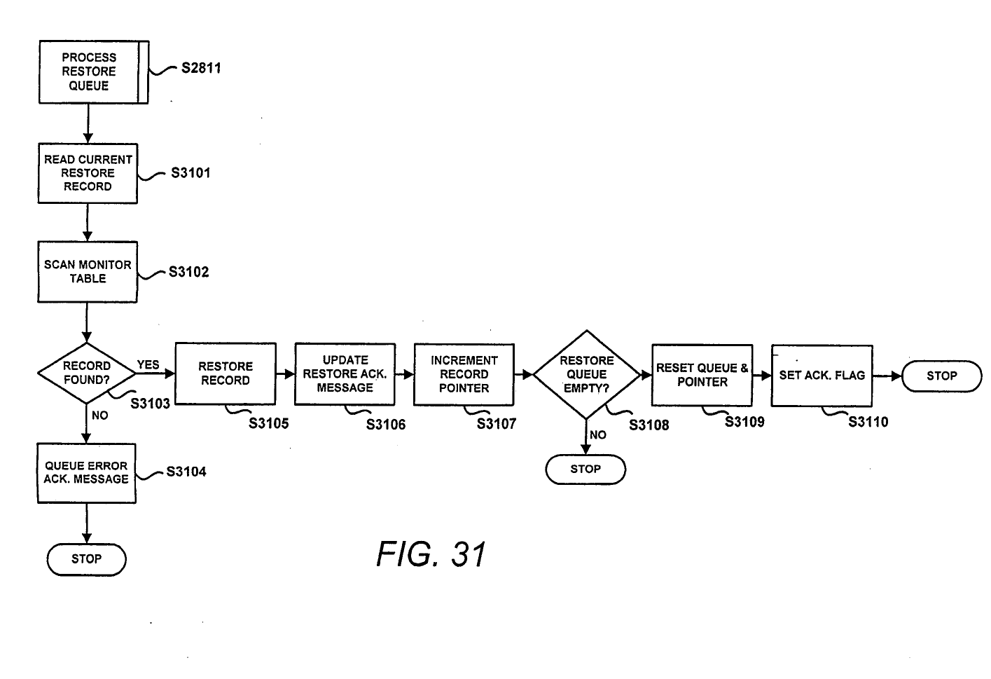

FIG. 31 illustrates the process steps performed at the SIM card of FIG. 17(b) during a restoration process;

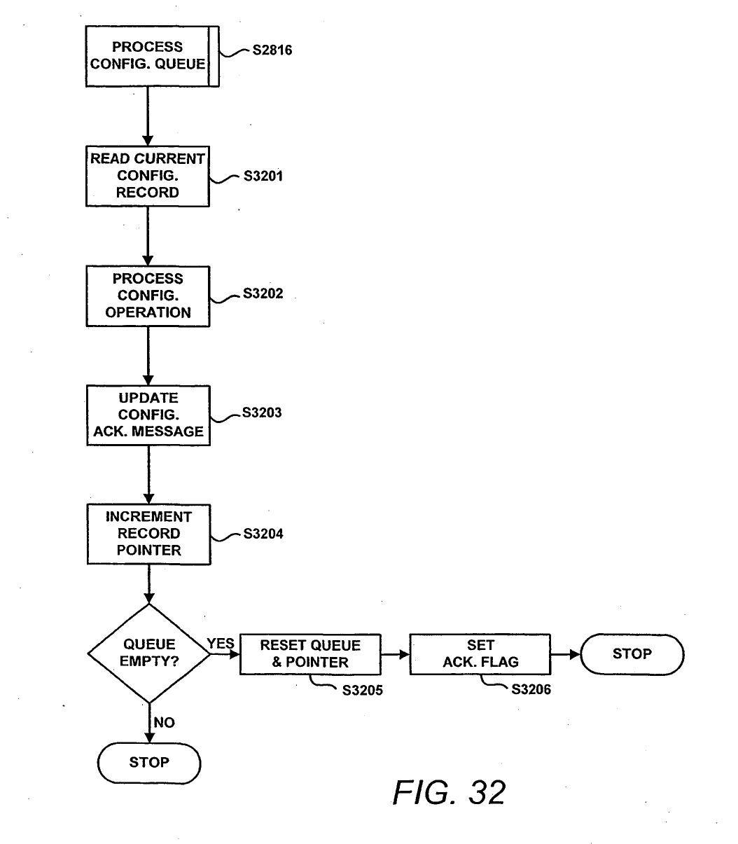

FIG. 32 illustrates the process steps carried out by the backup and restore processing unit incorporated in the SIM card of FIG. 17(b) during the processing of a configuration queue.

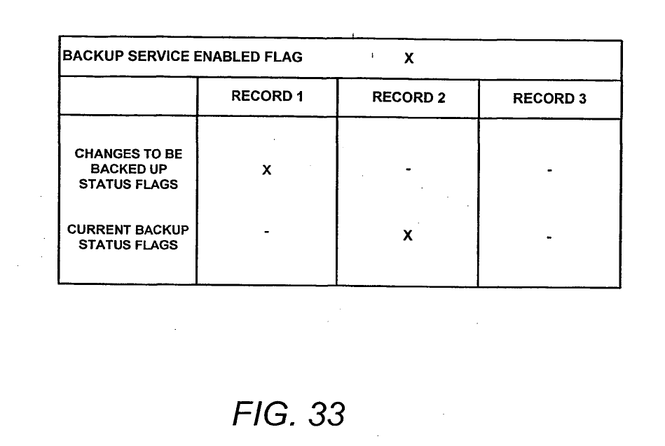

FIG. 33 illustrates an alternative backup file configuration used in the mobile station in the third embodiment of the invention;

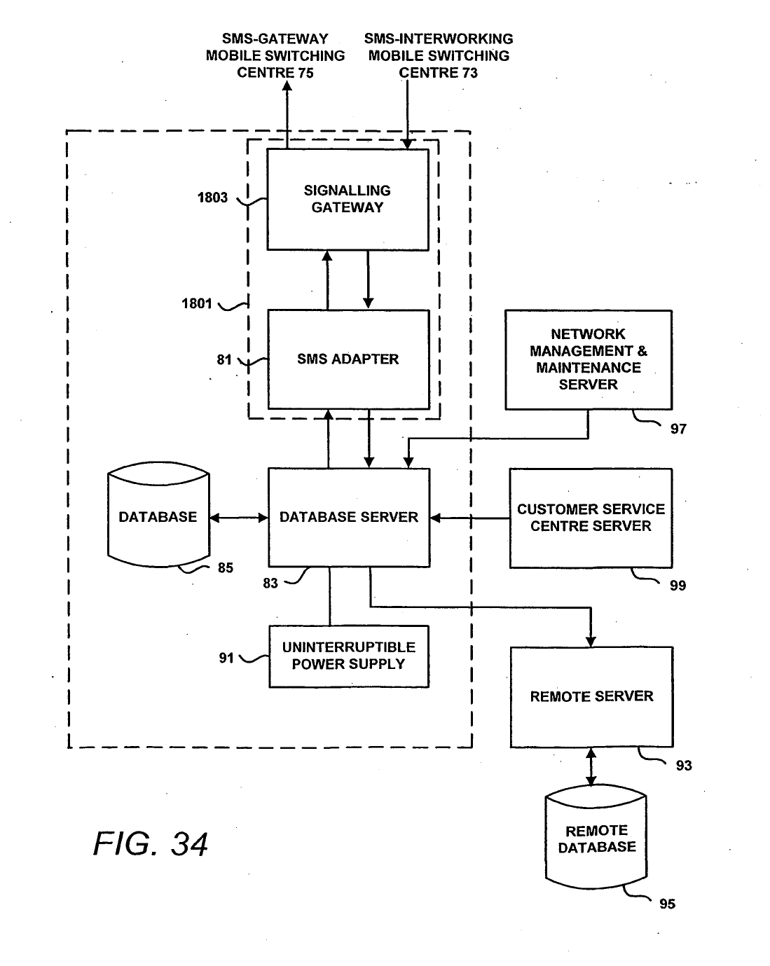

FIG. 34 illustrates an alternative backup service centre configuration used in the third embodiment of the invention;

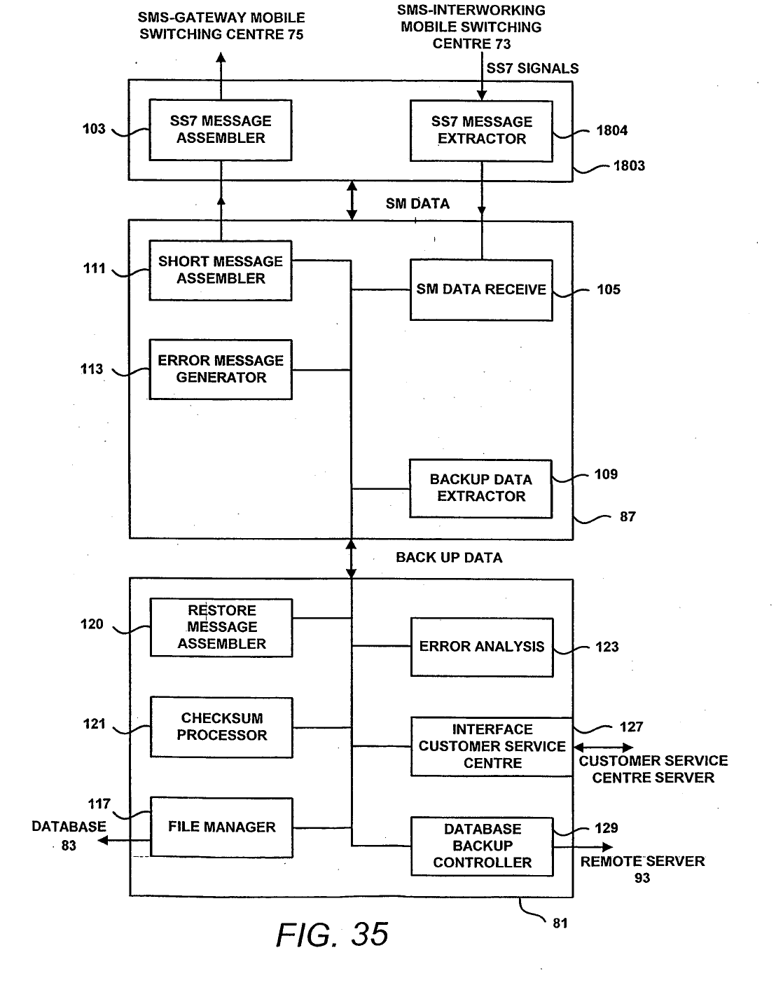

FIG. 35 illustrates the functional modules of software and hardware incorporated in the service centre of FIG. 34;

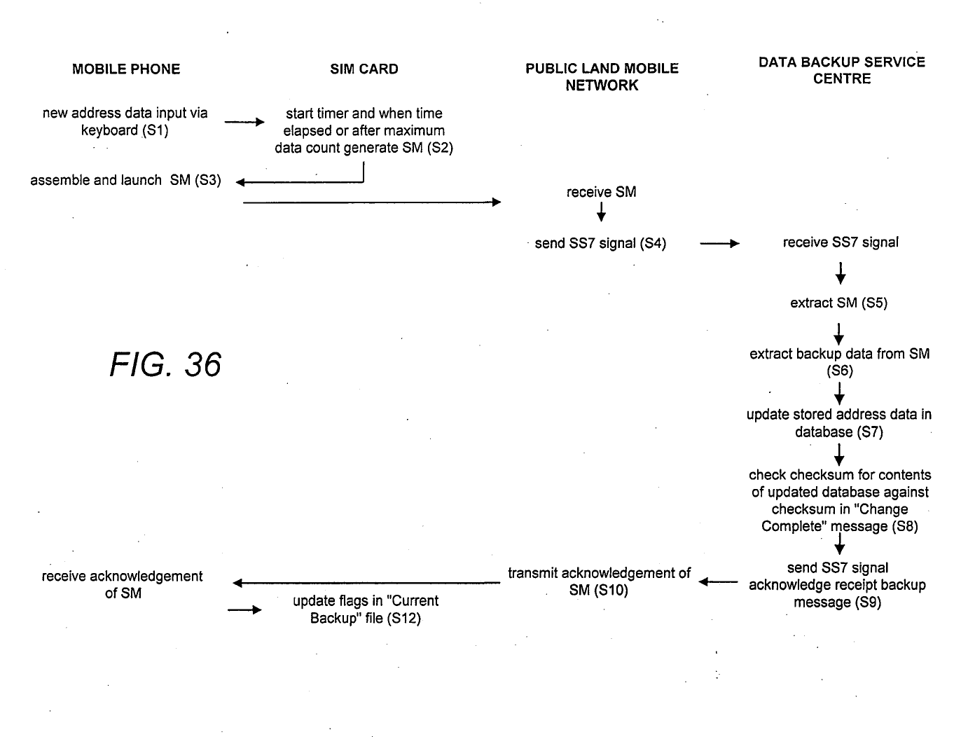

FIG. 36 illustrates the process steps performed in the system of the third embodiment of the invention; and

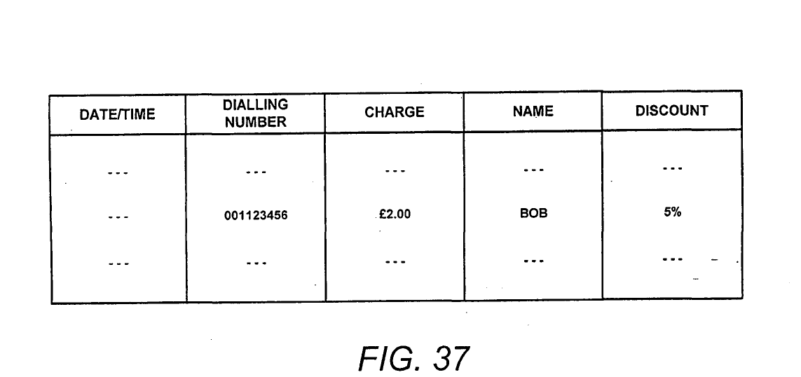

FIG. 37 illustrates a bill produced using an itemised billing process in accordance with an embodiment of the invention.

### First Embodiment: Overview

Referring firstly to FIG. 1, this figure illustrates the overall operation of a data backup system in accordance with a first embodiment of the invention. In this particular embodiment, data stored on each of a number of mobile stations 1a, b, c may be backed up at a backup data service centre 3. The data to be backed up is transmitted by a wireless link between each mobile station 1a, b, c and a public land mobile network 5, the data then being sent to the backup data service centre 3 via a Short Message Service Centre 6.

Each mobile station consists of a mobile phone 7 in which a respective SIM card 8 is inserted, a radio link being established between an antenna 9 on the mobile phone and an antenna 11 within the public land mobile network 5. Appropriate software modules are incorporated in the SIM card 8 in each mobile station 1a, b, c in order to enable the data backup system to operate as will be described in more detail hereafter.

The data transfer between each mobile station 1a, b, c and the data backup service centre 3 in this particular embodiment takes place using the point-to-point Short Message service (SMS) facility as defined in part 03.40 of the GSM specification. This SMS facility enables short text messages and other data of up to 140 octets (in the GSM specification 1 octet equals 8 bits) to be sent in a store and forward manner to or from a mobile station in TDMA timeslots other than those used to contain speech data.

The basic format of each SMS message is illustrated in FIG. 2 and comprises transport protocol (TP) data 13 and a payload 15. The transport protocol (TP) data 13 relates to the type, destination and originator of the message as defined in the GSM specification and as will be described in more detail hereafter, this information being inserted in a conventional manner for a Short Message by appropriate software modules in the mobile phone 7. The payload 15 includes, for example, backup data as user defined data produced by the SIM card 8, as will also be described in more detail hereafter. On receipt of the SMS message including the backup data, the backup data service centre 3 is able to store a backup version of the data transmitted from the mobile station 1, which in the event of loss of the SIM card, or corruption of the data on the SIM card, may be used to restore the data. The data may also be used for functions other than backup, such as itemised billing, or for enabling downloading of the same data to a number of mobile stations, for example, in the case of a company address book.

For messages from the backup data service centre 3 to the mobile stations 1, the Short Message Service will usually be the class 2 message service, that is where the Short Messages are not displayed on the display of the mobile phone. However the class 1 message service may be used where appropriate signals are transmitted to avoid the display of incoming Short Messages on the display. For messages from the mobile stations 1 to the backup data service centre 3, the message class is not restricted in any way.

The individual components of the data backup system will now be described in more detail.

### First Embodiment: Mobile Station

Referring now to FIG. 3, this figure describes schematically the functional modules of software and data incorporated in the mobile phone (FIG. 3(a)) and the SIM card (FIG. (3b)) in so much as they are necessary to understand the present invention. Further components which are conventionally included in mobile stations, for example for receiving and transmitting speech data, have been omitted for the sake of clarity.

Referring firstly to FIG. 3(a), the operation of the mobile phone is controlled by a software control module conventionally known as a phone kernel 21. This controls a radio manager module 22, which in turn controls the transmission of signals to be transmitted by antenna 9 to the public land mobile network 5, or the processing of signals received by the antenna 9 from the public land mobile network 5.

An SMS reception unit 23 is arranged to process incoming SMS signals dependent on data within the transport protocol 13 to display the message on a display (not shown) under the control of a display control unit 24 when the SMS data contains a conventional Class 1 Short Message including a text message. Alternatively, where it is determined that the incoming SMS signal includes information relating to the SIM card 8, such as information relating to backup data transfer to the backup service centre 3, or, in the case of a data restore operation, data downloaded from the backup service centre 3, a SIM manager unit 25 within the mobile phone 7 is arranged to pass appropriate signals to an interface on the SIM card 8 as will be described in more detail hereafter.

The mobile phone 7 also includes an SMS assembly unit 26 which is arranged to incorporate appropriate GSM transport protocol data in SMS messages to be transmitted through the antenna 9 under the control of the radio manager 22.

A keyboard (not shown) enables a user to input instructions to a keyboard interface 27 which is effective to interpret the instructions and distribute appropriate signals within the rest of the mobile phone. A clock 28 is effective to produce timing signals for use by the mobile phone 7 and to produce polling signals which are sent to the SIM card 8. Finally, the phone is provided with an area of RAM 29 effective to store, amongst other data, a copy of abbreviated dialling numbers and a copy of the incoming SMS messages which are sent to the SIM card 8 as will be described in more detail hereafter.

Turning now to FIG. 3(b), the operation of the SIM card 8 is controlled by control software conventionally called a SIM kernel 31. A data communication protocol unit 32 is effective to receive and to transmit signals to or from the mobile phone 7. A card holder verification processor 33 is programmed with security data for verifying the authenticity of a security number (CHQ) derived from the PIN number typed in by the user using the keyboard on switching on the mobile phone in order to verify the identify of the user.

The SIM card 8 also includes a file manager 34 effective to-control the input and output of data into a number of files stored within an EEPROM memory 35 on the SIM card 8. These files include a number of so-called “elementary files” including an abbreviated dialling numbers file EF_{ADN} 36 and a file EF_{SMS} 37 for storing the latest incoming SMS messages. The elementary files also include other elementary file data such as preferred networks, the dialling numbers of recent calls, etc, but these have been omitted from the drawing for the sake of clarity.

The EEPROM 35 also includes a buffer area 38 called a SMS transport protocol data unit (SMSTPDU) for storing SMS data prior to transfer to the mobile phone 7 as will be described in more detail later.

Turning now to FIG. 4, this figure shows the basic structure of the abbreviated dialling numbers file EF_{ADN} 36. This file structure data is in accordance with the GSM specification GSM 11.11. Each entry has an entry number i and includes a so-called “Alpha Identifier” giving some form of identification for the particular number specified by the user, for example “BOB” or “HOME”. The next field includes the length of the data in the entry followed by the type of telephone number, for example, whether the number includes International dialling codes. The dialling number then follows, followed by information relating to the network operator and a final field identifying whether the entry overflows onto another record, and if so, the location of the other record. The overall length of each entry can be up to 254 bytes, but will typically be 30 bytes. Typically, a private user will have 30 entries in the EF_{ADN} file, although up to 200 entries can usually be accommodated.

As so far described, the SIM card is of conventional form. However, to enable the backup of data stored, for example, in the abbreviated dialling number file EF_{ADN}, the SIM card also includes an additional software module comprising a backup and restore processing unit 41 which will be described in more detail hereafter. This is incorporated in the SIM card 8 as an Applet either during provisioning of the SIM card or as a download during operation of the SIM card. The backup and restore processing unit 41 cooperates with the other functions on the SIM card via the SIM Application Tool Kit 43 which is conventionally included in SIM cards and includes a set of commands and procedures which enables applications existing in the SIM card 8 to interact and to cooperate with applications in the mobile phone, or the network.

The features of the SIM application tool kit 69 are defined in GSM Standard 3GPPTS 11.14 and in particular include a “Send Short Message” function 45 enabling the SIM card 8 to send data for incorporation in a Short Message to the mobile phone 7 and a poll signal control unit 47 effective to change the frequency of the polling signals which are produced by the clock 45 on the mobile phone 7.

In particular, the poll signal control unit 47 is used to cause the clock 45 to send polling signals at five second intervals during the “idle” periods for the phone 7 following times at which the display on the phone has been refreshed, this being a time when the SIM card is usually inactive. The interval of five seconds is chosen as being a time which the user of the mobile phone is likely to find unobtrusive, although other time intervals may be chosen to suit the particular circumstances.

In addition to the backup and restore processing unit 41, the SIM card 8 is provided with backup files 49 in the EEPROM memory 35 for monitoring the backup procedure as will be described in more detail hereafter.

Referring now to FIG. 5, this figure illustrates the functional units included in the backup and restore processing unit 41. The unit 41 is controlled by an event manager 51 which reacts to either:

(1) Incoming Short Messages received from the mobile phone 7 which have been determined as including information relating to the backup service; or

(2) Polling signals received from the clock 28 on the mobile phone 7.

In particular, the event manager 51 controls the functioning of an incoming message manager 53 arranged to handle incoming Short Messages which have been determined as including information relating to the backup service and a scheduler 55 responsive to the polling signals. The event manager 51 is arranged such that the incoming Short Messages always have priority over the polling signals.

The incoming message manager 53 is arranged to analyse the contents of the information within the incoming Short Messages to determine whether the information is for:

(1) A service state manager 57 in the event that the information includes “ON”/“OFF” state messages, that is, whether the backup service should be switched “ON” or “OFF”;

(2) A restore manager 59 in the event that the message includes restore information; or

(3) An acknowledgement manager 61 in the event that the information includes acknowledgement information as to whether a successful backup operation has taken place.

Where there is no incoming Short Message, on receipt of a polling signal by the event manager 51, the scheduler 55 determines whether any backup processing has to be performed and, if so, allocates the time slot to a backup manager 63. In the event there is no outstanding backup to be performed, the scheduler allocates the time slot to an “idle” processor 65 whose function is to interrogate the backup file 49 stored in the EEPROM memory 35 to determine whether the EF_{ADN} file requires backing up. A brief description of the backup file 49 and the “idle” processing will now be given.

Referring now also to FIG. 6, this figure illustrates the form of the backup file 49 stored in the memory 35. In respect of each EF_{ADN} entry as illustrated in FIG. 4, the backup record stores a 16 bit checksum calculated from the EF_{ADN} data for that particular record. During the “idle” processing, the checksum based on the EF_{ADN} data for the entry is re-calculated and compared with the stored checksum. A “change” flag is then set dependent on whether the checksum is the same as the stored checksum. Thus, in FIG. 6, the checksum for record “BOB” has changed indicating that the EF_{ADN} data for record “BOB” has changed since the entry was last backed up.

The interaction between the various backup, “idling”, restore, and acknowledgement processing will be described in more detail later.

### Public Land Mobile Network

The basic features of the public land mobile network (PLMN) 5 will now be described in only as much detail as necessary to describe the transmission of a Short Message between the mobile station 1 and the data backup service centre 3.

Referring now to FIG. 7, the PLMN 5 includes a base transceiver station (BTS) 67 effective to establish a radio link between the mobile station 1 and the PLMN 5. The BTS 67 operates under the control of a base station controller (BSC) 69. The BTS 67 serves a geographical area constituting one cell of a cellular communication system, the mobile station 1 being located within this cell. It will be appreciated that, whilst in FIG. 7 only one BTS 67 is shown, other BTSs under the control of the BSC 69 will be provided with a PLMN 5, each BTS being effective to establish a radio link with mobile stations in different geographical areas or cells.

The BSC 69 is connected through a mobile switching centre (MSC) 71 to an SMS-Interworked Mobile Switching Centre (SMS-IWMSC) 73 effective to direct Short Messages to the data backup service centre 3 and an SMS-Gateway Mobile Switching Centre (SMS-GMSC) 75 effective to receive Short Messages from the data backup service centre. 3. The SMS-GMSC 75 is also connected to a home location register (HLR) 77 effective to store subscriber information for the network relating to which services any particular mobile station is registered. A visitor location register (VLR) 79 is connected to the MSC 71, the VLR being effective to determine the state of the mobile station to which a message is to be sent, and in the event that the mobile station is switched off, to hold the message until it is possible to transmit the message when the mobile phone 7 is next switched on.

### First Embodiment: Data Backup Service Centre

Referring now to FIG. 8, this figure illustrates the components of the data backup service centre 3. An SMS adaptor 81 is arranged to perform an interface to incoming and outgoing messages from the Short Message Service Centre 6, the messages being conventionally transmitted as SS7 signals. The adaptor 81 is connected to a database server 83 which in turn is arranged to address database 85.

In order to provide as resilient a service as possible, the database server 83 is provided with an uninterruptable power supply 87 and is configured with suitable disc redundancy, the database 85 being designed to be backed up on a regular, generally daily basis. In addition, the database 85 is provided with a hardwired link to a remote server 89 provided in a different site which is arranged to address a remote database 91, this enabling a copy of the data within the database 85 to be made to protect against the possible catastrophic destruction of the site in which database 85 is located. Inputs to the database server are also provided from a web server 93, a billing system processor 95 and a customer service centre server 97.

Referring now also to FIG. 9, this figure illustrates in more detail the functional software modules within the SMS adaptor 81 and the database server 83. The SMS adaptor 81 includes a unit 100 effective to receive the Short Message data produced by the Short Message Service Centre 6 and a backup data extractor 101 effective to extract the backup data from the message and send this to the database server 83. The SMS adaptor 81 also includes a Short Message assembler 102 effective to assemble data signals received from the database server 83 in a Short Message and send Short Message data to the SS7 message assembler 102, and an Acknowledgement message generator 103 effective to generate Acknowledgement messages for incorporation in Short Messages assembled by the Short Message assembler 102. Finally, the adapter 81 includes an interface 104 enabling transfer of backup and restore data between the adapter 81 and database server 83.

The database server 83 includes a corresponding interface 105 to the adapter 81, and a file manager 106 for controlling the entry of data into the database 85. The database server 83 further includes a restore message assembler 107 for assembling restore data to be transmitted back to the mobile station 1 in the event of a restore operation. The server 83 further includes a checksum processor 108 effective to produce a checksum on data backed up by the database 85 and an error analysis processor 107 effective to analyse errors occurring in received backup data so as to enable error messages to be sent back through the system to the mobile station 1, or for the backup service system operator to be alerted.

Finally, the database server 83 includes interface 110 to the customer service centre server 97 and a database backup controller 111 for interaction with the remote server 93.

### First Embodiment: Data Structure of the SM Signal Including Backup Data

More details of the Short Message format illustrated in FIG. 2 will now be given.

The transport protocol data 13 at the start of the SMS message is determined by transport protocol (TP) data specified in GSM 03.40, and in the particular case illustrated in FIG. 2 includes as a minimum the following data fields:

TABLE 1
Transport Protocol Data in Short Message

| REFERENCE | DESCRIPTION |
|---|---|
| TP-Message-Type-Indicator | Parameter describing the |
| | message type, i.e. a SM |
| | as transmitted by a |
| | mobile station. |
| TP-Reject-Duplicates | Parameter indicating |
| | whether or not the Backup |
| | Data Service Centre shall |
| | accept an SMS message for |
| | a Short Message still |
| | held in the Service |
| | Centre as a previously |
| | submitted Short Message. |
| TP-Validity-Period-Format | Parameter indicating |
| | whether or not the TP-VP |
| | field is present. |
| TP-Reply-Path | Parameter indicating a |
| | request for a Reply Path. |
| TP-Message-Reference | Parameter identifying the |
| | ISDN number of the mobile |
| | station. |
| TP-Destination-Address | Parameter identifying the |
| | ISDN number of the Backup |
| | Data Service Centre. |
| TP-Protocol-Identifier | Parameter identifying the |
| | layer protocol, if any. |
| TP-Data-Coding-Scheme | Parameter identifying the |
| | coding scheme within the |
| | backup data. |
| TP-User-Data-Length | Parameter including the |
| | length of the backup data |
| | to follow. |

This data includes the address of the backup data service centre such that the network is able to send Short Messages originating from the mobile station 1 to the data backup service centre 3 via the Short Message service centre 6. The transport protocol also indicates the length of the backup data to follow.

Turning now to the form of the backup data included in the SMS message, a typical data structure is shown in FIG. 10. Each set of backup date comprises 117 bytes of which the first byte is a message ID, that is, a parameter identifying that the message includes backup data. The remaining 116 bytes comprise four sets of 29 bytes of which the first byte corresponds to the abbreviated dialling number record number i and the next 28 bytes comprises the abbreviated dialling number EF_{ADN} data entry as indicated in FIG. 4. Where the record number is set at zero, this indicates that the following data fields are empty.

The backup data structure will also be used in Short Messages transmitted during restore processing where information is being received by the mobile station 1 from the backup service centre 3. In this case, the ID identifier at the beginning of the data will indicate that the data is restore data.

Backup operations are completed by receipt by the mobile station 1 of a Short Message including acknowledgement data of the form indicated in FIG. 11. This data structure comprises nine bytes commencing with an ID byte indicating that the data is acknowledgement data and then four sets of two bytes. The first byte in each pair of bytes comprises the record number i of the EF_{ADN} data, whilst the second byte indicates whether the latest backup operation has been successful or not. Where the first byte in each pair is set at zero, this indicates that the following data field is empty.

### First Embodiment: Operation of the Data Backup System

1. “Idle” Processing

Referring now to FIG. 12, as mentioned above, in the absence of an incoming Short Message during the “idle” processing, the backup file 49 illustrated in FIG. 6 is interrogated to determine whether any of the EF_{ADN} data entries have been changed since the last backup procedure and thus require backing up. The “idle” processing is designed to take place in time slots of less than five seconds, that is, less than the time intervals between the polling signals received from the mobile phone. Thus, it will take many “idle” processing sessions to complete the interrogation of a typical abbreviated dialling number address book of 100 entries.

At the start of the “idle” processing procedure in step S1201, the count j of the number of entries stored in the current backup Short Message SM(1) stored in the SMS transport protocol data unit (SMSTPDU) buffer 38 is investigated within the scheduler 55 and it is determined whether count j, that is the number of backup data entries waiting to be sent stored in the buffer 38, is less than 4, that is, whether the maximum number of backup data entries has been incorporated in the current Short Message. If the count j has reached 4, it is then determined in step S1202 whether the count n indicative of the time since a backup message was last sent, that is the time since j became greater than 0, is less than 20. If n is less than 20, then “idle” processing proceeds. Alternatively, if j has reached 4 or the count n has reached 20, that is a “time out” condition is fulfilled, the processing switches to backup processing as will be described in the next section.

In the event that the “idle” processing procedure does continue using the “idle” processor, the entry number (i) of the address book entry is incremented in step S1203 to determine the entry number i which is going to be interrogated.

In step S1204, it is determined whether the count j is greater than zero., that is, there is backup data waiting to be sent stored in the buffer 38, and if so, the counter n indicative of the time since a backup message was last sent is incremented in step S1205. In step S1206, it is determined whether the entry number i is equal to 100, that is, whether the end of the file has been reached on the assumption that there will be a maximum of 100 entries in the EF_{ADN} file and, if so, in step S1207 the entry number i is reset to 1 to restart the reading of the entries in the backup file 49. In step S1208, it is determined whether the abbreviated dialling number data entry for entry i is, in fact, empty. If the entry is not empty, the checksum CHQ(i) is calculated in step S1209 and, in step S1210, CHQ(i) is compared with the checksum for entry i stored in backup file 49.

Referring now also to FIG. 6, in the event that the calculated checksum CHQ(i) is different to the stored checksum, the change flag in the backup file 49 is set to 1 indicating there has been a change in the entry resulting in the change to the,checksum for the entry. The current data for the entry is added to the SMS transport protocol data unit (SMSTPDU) buffer 38 in the EEPROM 35 and the count j of entries in the current Short Message is incremented in step S1213.

2. Backup Processing

The backup processing procedure is illustrated in FIG. 13. In step S1301, the Short Message including backup data structured as shown in FIG. 10 and stored in buffer 38 is transmitted via the mobile phone 7 and the Short Message service centre 6 to the data backup service centre 3. At the data backup service centre 3, the backup data extractor unit 109 is arranged to extract the backup data, the file manager 101 within the server 83 being arranged to overwrite the appropriate data in the database 85.

In step S1302, the buffer 38 storing the current Short Message SM(4) in the SIM card is cleared and in step S1303 the appropriate flag and counters are reset. In particular, the server acknowledgement flag p is set to 1 indicating that an acknowledgement message from the data backup service centre 3 is pending. The counter j indicating the number of pending backup data messages in the current Short Message stored in the buffer 38 is set at zero and the counter n indicating the elapsed time since j was greater than zero is also set to zero.

This then completes the backup processing at the SIM card 8 until the next “idle” processing takes place which initiates the next backup processing.

It will be appreciated that whilst the above describes the basic processes performed in assembling and transmitting the SMS message including the backup data, there are various other possibilities. In particular, the backup data may undergo compression in particular by the backup manager 63 before transmission of the backup data. This may be particularly appropriate where the ADN data includes a number of blank fields. Encryption may alternatively or additionally be performed.

3. Acknowledgement Processing

Following a backup operation, the change flags P for each backed up entry in the backup file 49 are not reset until receipt of an acknowledgement message from the backup service centre 3. The acknowledgement messages are of the form indicated in FIG. 11.

In acknowledgement processing by acknowledgement manager 61, following receipt of an acknowledgement message in step S1401, a counter N is set to 1. It is then determined from the first byte following the ID byte within the acknowledgement data message whether the entry includes acknowledgement data for the designated entry number i in step S1402. If the following acknowledgement data in the subsequent byte is positive, the change flag P is cleared for the designated entry in step S1403. As the acknowledgement processing is arranged that acknowledgements can be processed for four entries in the five second time slot provided by the polling signals, the value of N is incremented in step S1404 and where the incremented value of N is less than 5, the process steps S1402-S1404 are repeated.

After all the data in the Acknowledgement message has been processed, in step S1406, the register for the incoming Short Message in file EF_{SMS} 37 is freed. A command is sent to the phone 7 via the data communication protocol unit 32 to refresh the corresponding incoming SMS entry in the RAM 29 in the phone 7. In step 1407 the server acknowledgement flag p is set to zero to indicate that no acknowledgements are pending.

There are various stages at which it may be determined that for some reason successful backup has not taken place. In the first instance, due to transport errors, the network 5 may not receive the transmitted message from the mobile station 1. Alternatively, the non-backup may be due to faulty transmission of the data within the transmitted Short Message. This will generally be picked up by the checksum processor 121 in the database server 83. In either event, the failure of the SIM card 8 to receive a positive acknowledgement signal will cause the server acknowledgement pending flag to remain at “acknowledgement pending” and the “change flags” in the backup files to remain set at “change” such that the backup data for the relevant entries will be re-transmitted to the backup service centre 3 when the entry for the backup file is interrogated during “idle” processing.

In a variation of this procedure, in the case of faulty data transmission, the error message generator 113 can be programmed to produce a control message in the form of a resynchronisation request which is assembled in a Short Message by the Short Message assembler 111 such that a Short Message is transmitted to the mobile station 1. Reception of this message will alert the backup manager 63 in SIM card 7 to transmit a series of Short Messages replicating the ADN data currently stored in the SIM EF_{ADN} files 36 to enable the two databases to be resynchronised.

Further error analysis may take place within error analysis unit 107 within the database server 83 where it is determined for example that the ADN data of an updated record is totally incompatible with data already stored on the database 83 or where it is determined that the user does not have a valid account with the data backup service. This will usually result in a message being sent to the user initiated by the customer service centre server 97 either via e-mail or some other form of communication.

4. Restore Processing

In the event that the user requires restoration of the EF_{ADN} data stored on the SIM card 8, due to, for example, loss of the SIM card or corruption of the data, this will normally be dealt with by the user contacting the customer service centre. An appropriate message will be sent through the customer service centre server 97 to the database server 83 to instigate the restore process either for all entries, or for a selected group of entries. In the event of the loss of the SIM card, this may conveniently be achieved by download of the data stored on the database 85 to a SIM manufacturer who is able to load the data.

Alternatively, the ADN data may be incorporated in a number of Short Messages using the Short Message assembler 111 in the SMS adaptor 87, the data being transferred via the network 5 within an appropriate number of SMS “restore” messages of the form shown in FIG. 10 so that all the data in the abbreviated dialling number file EF_{ADN} is transmitted as will now be described with reference to FIG. 15.

Before restore processing takes place, the restore manager 59 is effective to check the transmitted data against the checksum incorporated in the transmitted restore data. If there is a discrepancy, a suitable warning signal is sent back to the backup service centre 3.

In restore processing, even where all the abbreviated dialling number entries must be restored, there being typically 100 such entries for a domestic user, the restoration takes place four entries at a time, this being determined by the available space capacity of an SMS message. In step S1501, a counter N is set to 1. It is then determined in step S1502 whether the first entry in the restore data will be of the form indicated by FIG. 10. The abbreviated dialling number entry ADN(N) is written into the backup file 49 in step S1503, the checksum is calculated and written in the backup file 49 in step S1504 and the flag P in the backup file 49 is set to zero in step S1505.

In step S1506, the value of N is incremented and in step S1507, where it is determined that the incremented value of N is less than 5, the process steps S1502-S1506 are repeated.

After four cycles, all the data within a single Short Message will be restored in the EF_{ADN} file 36 in the SIM card 8. In step S1508, the current incoming Short Message SM(1) in the elementary file EF_{SMS} 37 is freed and the corresponding entries in the abbreviated dialling number file and the incoming Short Message file in the RAM 29 in the mobile phone are refreshed. Finally, in step S1509 the counter N is set to zero.

It may be arranged that the mobile phone display displays a message to the effect that successful restoration has taken place.

### Alternative Signalling System Configurations

Whilst the backup of data using the Short Message service as the transfer means for transmission of data between the mobile station and the public land mobile network 5 is particularly convenient as, at present, use of the Class 2 Short Message Service (i.e. Short Messages which are not displayed on the display of the mobile phone) is free to the user, it will be appreciated that there are other ways in which the data may be communicated between the mobile station 1 and the data backup service centre 3, In particular, the transfer may take place by means of transfer of unstructured supplementary service data (USSD). Alternatively, data packet switching may be used, or in WAP enabled mobile stations, an Internet connection. The second embodiment to be described includes a system configured such that the mobile stations and the backup data service centre can communicate in a variety of manners.

### Second Embodiment: Overview

Referring to FIG. 16 in which like features to those of FIG. 1 are correspondingly labelled, in the second embodiment of the invention to be described, the system is configured such that the mobile stations 1a, 1b, 1c and backup data service centre 3 can communicate using either the short message service or via the Internet. In this embodiment, the backup and restoration is again of abbreviated address book data, i.e. EF_{ADN} data, although it will be appreciated that any data stored on the SIM card can be backed up and restored.

The SIM card is arranged to transmit to the data backup service centre, via the mobile phone:

(1) Backup Messages including data to be backed up at the data backup service centre;

(2) Restore Acknowledgement Messages in response to restore messages from the data backup service centre in the event of a successful, or unsuccessful, restore operation at the SIM card;

(3) Error messages in the event of failed message transmissions or system anomalies; and

(4) Configuration Acknowledgement Messages in response to configuration messages received from the backup and restore service centre.

The data backup service centre is arranged to transmit to the SIM card:

(1) Backup Acknowledgement Messages following successful, or unsuccessful, backup;

(2) Restore Messages including data to be restored on the SIM card; and

(3) Configuration Messages for changing the configuration settings of the SIM card.

Rather than by periodically interrogating the address book data (i.e. EF_{ADN} data) to look for changes as in the first embodiment, backup messages are initiated by entry of new ADN data via the keyboard of the mobile phone. Restore messages, as in the first embodiment, are instigated by a user request to the backup data service centre, whilst configuration messages will usually be instigated by the data backup service system operator.

### Second Embodiment: Mobile Station

Referring firstly to FIG. 17, this figure illustrates schematically the functional modules of software and hardware incorporated in the mobile phone (FIG. 17(a)) and the SIM card (FIG. 17(b)). Where the functional units are the same as in the mobile phone or SIM card shown in FIG. 3 described in relation to the first embodiment, corresponding reference numerals have been used.

The mobile phone used in FIG. 17(a) differs from the mobile phone shown in FIG. 3 in that it is adapted to receive messages from the Internet in the form of IP signals and to transmit such signals. Accordingly, the mobile phone includes an IP message reception unit 170 and an IP message assembler unit 171. The backup and restore processing unit 172 incorporated in the SIM card 8 is also configured to act differently to the backup and restore processing unit 41 described in relation to the first embodiment as will be described in detail later. Finally, the EEPROM 35 incorporated in the SIM card 8 includes different backup and restore service files 173 to those described in relation to the first embodiment. In particular, the EEPROM 35 includes backup and restore service buffers 173, 174 as will now described with reference to FIG. 18.

Referring now also to FIG. 18, the backup and restore service files 173 include a configuration table 175, a monitor table 176 and a checksum table 177.

The configuration table 175 includes data recording the following information:

(1) Whether the backup and restore service is functional (this being dependent, for example, on whether the user has subscribed to the service).

(2) The IP and ISDN addresses of the data backup service centre.

(3) The preferred channel by which the SIM card and the data backup service centre will communicate.

The monitor table 176 includes data specifying which files, records and data are to be monitored and backed up. As the EF_{ADN} data is arranged in accordance with the hierarchical file structure specified in GSM 11.11, the data in the monitor table is recorded in terms of the dedicated file (DF) number and the elementary file (EF) number within the dedicated file group, although it will be appreciated that alternatively a main file (MF) and an elementary file (EF) within the main file group may be used to specify the file. As the EF_{ADN} records are recorded in linear elementary files, in order to identify which records within the elementary file are to be monitored, the monitor table also defines the record range offset and length, and within each record, in order to identify the data within the record, the data range offset and length. The monitor table will, thus, typically have the form set out in Table 5:

TABLE 5
Monitor Table

| Field | Length (bytes) |
|---|---|
| DF | 2 |
| EF | 2 |
| Record range offset | 1 |
| Record range length | 1 |
| Data range offset | 2 |
| Data range length | 1 |
| Total | 9 |

The checksum table 177 includes data specifying which records require checksum comparisons and the latest checksums for each record specified in the monitor table.

The checksum table will typically have the form set out in Table 6:

TABLE 6
Checksum Table

| Field | Length (bytes) |
|---|---|
| Index into Monitor Table | 1 |
| Record number | 1 |
| Checksum | 2 |
| Total | 4 |

The EEPROM 35 also includes the following buffers:

(1) An event buffer 181 for buffering incoming events;

(2) An inbound message buffer 182 for buffering inbound restore, configuration and backup acknowledgement messages for further processing;

(3) A restore/configuration buffer 185 for buffering restore data and configuration message data;

(4) An outbound message buffer 183 for storing data used to build data backup messages;

(5) An acknowledgement message buffer 184 for buffering outgoing restore acknowledgement messages; and

(6) An error message buffer 186 for buffering outbound error messages.

Further details of the operation of each of these buffers will be described later.

### Second Embodiment: Data Backup Service Centre

This particular embodiment of the data backup service is particularly configured to enable further input channels, for example, circuit switched data (data packet switching) or transfer of unstructured supplementary service data (USSD), to be added without affecting the rest of the data handling system or control functions. The system also allows extra or alternative functionality to be added to the system without requiring reprogramming of the low level procedures used to address the database system.

This is achieved by designing the data backup service centre with the following layers:

(1) Processors for enabling the input of the data received from the SIM card to the database and the output of data from the database for transmission to the SIM card;

(2) The database system;

(3) An interface for interfacing the database system with an application server so as to allow the application server to use common codes, subroutines and methods; and

(4) An application server for controlling the functionality of the data backup service centre and having system operator interfaces to, for example, a customer service server.

Furthermore, the system is designed to be scaleable both horizontally, that is in terms of having a single copy of the software installed on faster and larger machines and vertically, that is by spreading the processing across multiple parallel processing units performing each function.

Thus, referring to FIG. 19, incoming data from user SIM cards is received by inbound channel processors 191 and processed by inbound data processors 193. Data is stored or retrieved from a database 195 controlled by a database management system 196 which includes an application software interface 219 to an application server 203 which is programmed to control the overall functioning of the system. Outbound data processors 199 control the data output processes, whilst output channel processors 201 transmit outbound signals to the SIM card. Whilst in FIG. 19 the inbound channel processors, the inbound data processor, the database system, the outbound processors and the outbound channel processors are all shown as different machines, it will be appreciated that some or all of these functional components can be run on the same machine.

The system is designed to accommodate differing communication channels for transmission of messages between the mobile station and the service centre. In the particular example, incoming and outgoing IP messages communicated by the Internet are shown together with the SS7 signals produced by a Short Message Service Centre 6 from incoming short message signals as shown in FIG. 16. The input signals are received by respective inbound channel processors 191(a), 191(b) provided for each respective input channel with multiple inbound channel processors 191(a), 191(b) being provided in each channel in order to accommodate a large volume of incoming traffic.

The inbound channel processors 191(a), 191(b) are connected through a load balancer 192 to a stack of inbound data processors 193 which in turn, in this particular embodiment, address a database and database management cluster 194 comprising a cluster of mirrored relational databases 195(a), 195(b) and associated database management systems 196(a), 196(b). Outputs from the database and database management cluster 194 are connected through respective load balancers 197, 198 to the stack of inbound data processors 193 and a stack of output data processors 199. The outputs of the outbound data processors 199 are connected through a further load balancer 200 to respective stacks of outbound channel processors 201(a), 201(b) for onward transmission of IP signals and SM signals to user SIM cards via the Internet or a telecom network system.

Finally, the application server 203 and a synchronising server 204 for synchronising data stored in the database system with other network applications are provided, the synchronising server 204 using, for example, the SyncML protocol to allow information to be synchronised across different devices (e.g. PDAs, mobile phones and corporate databases). The application server 203 also interfaces with a customer service server 205. Further connections will be provided between the customer service server 205 to the inbound data processor (193) and the outbound data processor (199), but these are not shown in order to simplify the drawing. Further servers such as a diagnostics server 206 are also provided, this having an interface to each of the inbound data processors 193, the outbound data processors 199, the outbound channel processors 201 and the application server 203, but only being shown interfaced to the inbound channel processors 191(a), 191(b) in order to simplify the drawing.

1. Database and Database Management System

Turning now to FIG. 20, this figure illustrates schematically the database management in the relational database system incorporated in the database and database management cluster of FIG. 19. It will be appreciated that items such as an uninterruptible power supply and separate backup databases have been omitted in order to simplify the figure.

The database may be any suitable relational database, one example being the Oracle 8i addressed by a Sun database server system. The database includes data files 211 whose contents will be described in more detail hereafter and control files 213 which control the input and output of data in the data files in a known manner as, for example, described in “Oracle Essentials”, 2nd Edition by Rick Greenwald, Robert Stackowiak and Jonathan Stern published by O'Reilly in June 2001.

The management system includes a multi-threaded server 214 for addressing the data files 211 and control files 213 and a system global area 216 programmed with control procedures 217, a database buffer cache for caching the input and output data to and from the database and an application software interface 219.

The application software interface 219, as shown in more detail in FIG. 21, includes an interface 221 to the inbound data processors 193, an interface 223 to the outbound data processors 199 and an interface 225 to the application software 225. The application software interface 219 also includes a database control language parser unit 227 effective to parse the high level language used in the application server and convert this to the SQL or other low-level language used to address the database. Likewise, the data translation unit 229 is effective to convert data which is input from the application server 203, for example, XML SOAP (extensible markup language simple object application protocol) data received from the customer service server 205, to logic level data for use in the database system 195.

Turning now to FIG. 22, this figure illustrates some of the data files included within the data files 211 in the database system 195.

The data files 211 include operational data for controlling the transfer of data 231 to and from the database and data maps 233 for mapping the data within the database. In respect of each user (i.e. subscriber to the data backup and restore service), the database includes data defining a user table 235 including data identifying the user via a user ID number and including details about the user such as his name, address and web login and password. A device table 237 includes data identifying the mobile phone and SIM card within the mobile station owned by the user and the ISDN number of the mobile station. A monitor table 239 contains data duplicating the contents of the monitor table 176 stored on the SIM card whilst a checksum table 241 contains data duplicating the contents of the checksum table 177 stored on the SIM card. Finally, a data table 243 includes a copy of the EF_{ADN} data as specified in the monitor table 239 which is to be backed up by the data backup service, the data table including a field specifying the User ID.

The database also includes an inbound actions table 249 which acts as a buffer for the events received from the inbound data processors 193 and an outbound actions table 251 which lists events to be handled by the outbound data processors 199 as will be described in more detail later.

The outbound actions table 251 will include the entries set out in Table 7.

TABLE 7
Outbound Actions Table

| Field | Description |
|---|---|
| UID | Identification of User |
| Type | Type of action, eg, restore, |
| | configuration |
| Subtype | Refinement of type, eg set |
| | state for configuration |
| Data | |
| Load Time/Date | Date and time item entered |
| | onto list |
| Acknowledgement | Flag to denote awaiting |
| pending | restore message |
| | acknowledgement from SIM card |

The type of outbound actions will include the following events:

Backup acknowledgement following successful (or unsuccessful) backup

Restore command to the user SIM card

Addressable restore command

Configuration message for the user SIM card

2. Inbound Channel Processor

Turning now to the functional components used to input and output data to and from the database system, referring to FIG. 23, each inbound channel processor 191 is effective to input the incoming IP or SMS signal via an input interface 271, parse the transport protocol data in the header to the signal in header parser unit 273 and remove the payload data in the message from the transport protocol data in unit 275. Each inbound channel processor includes an output interface through which the data can be passed to the inbound data processor 193.

Each inbound channel processor also includes a configuration file 281 for storing all the operating parameters for the inbound channel processor, this configuration file being modifiable through an interface (not shown) to an operator console (not shown). Each inbound channel processor also includes an event buffer 280 for buffering each incoming signal before it is dealt, with by the header parser 273 and payload removal 275 and output interface 277.

Each inbound channel processor also includes a system log 282 which logs all events such as start up, shut down, communication failures and other actions to the inbound data processor and the arrival of inbound messages etc.

Each inbound channel processor has an interface 283 to a diagnostics server 206 for providing a diagnostics report of the logged events using Simple Network Management Protocol (SNMP). An interface 285 is also provided to the customer services server 265 which enables the customer services server 205 to compile billing information in the event the backup and restore system operator decide to bill on the basis of all incoming signals received by the inbound channel processors 191.

3. Inbound Data Processor

Turning now to FIG. 24, the inbound data processors 193 are arranged to do most of the processing for the data backup service centre relating to the payload data received from the inbound channel processor via an input interface 291. Incoming messages are held in an inbound message buffer 293 and processed in an inbound data processor 295, the incoming messages including a data bit identifying whether the message is a backup request, a message from a SIM card, a restore acknowledgement message, a configuration acknowledgement message or an error message as will be described in more detail hereafter.

Where the incoming message is determined to be a restore acknowledgement message, or a configuration acknowledgement message, these are passed through the application interface software 307 to the database files where they are matched against,stored outgoing restore or configuration message entries in the outbound actions table 251.

The inbound data processors also include a checksum processor 307 for calculating checksums in the incoming backup data and causing the checksums in the checksum table 241 in the database files to be overwritten, communication to the database files taking place via the interface 307 to the database and database management cluster. Where the incoming message is an error message, this is logged in an error analysis processor 305. The error analysis processor 305 is generally effective to analyse errors occurring on the system and, if necessary, sending an appropriate error message to the SIM card via the outbound channel processors 201, and/or providing a report to the customer service server 205 through customer service server interface 309.

4. Outbound Data Processor

Referring now to FIG. 25, the outbound data processors 199 include an input interface 313 to the application software interface 219, an output interface 315 to the outbound channel processors 201 and an interface 316 to the customer service server 205. An action processor 317 is effective to read actions on the outbound actions table 251 stored on the database 195 and place these in an action queue 319 within the outbound data processor 199.

Where the outstanding action stored on the actions table 251 is the generation of a backup acknowledgement message following a successful backup operation, a backup acknowledgement message generator 324 is arranged to produce a backup acknowledgement message and send this to an outbound channel processor 201 for transmission via the outbound channel processor 201 back to the originating SIM card.

When the action received from the application software interface 219 is the production of a restore message, this data is held in the outbound message buffer 321 pending the assimilation of the correct amount of data to include in a short message or an IP message dependent on the configuration setting of the SIM card.

The outbound data processors 199 include a number of message generators as follows:

(1) An restore message generator 323;

(2) A backup acknowledgement message generator 324;

(3) An addressable restore message generator 325; and

(4) A configuration message generator 327.

Where possible messages are incorporated in the same outgoing message to reduce bandwidth, the messages being held in the outbound message buffer 321 until being sent to an outbound channel processor 201.

5. Outbound Channel Processor

Turning now also to FIG. 26, the outbound channel processors 201 are effective to receive messages from the outbound data processors 199, assemble the messages in a message assembler 312 enveloped with the correct transmission protocol for the IP or short message service and launch the messages via message launch system 313. Error messages generated by the inbound data processors 193 are also received via interface 315 and enveloped in message assembler 312 for transmission via message launch system 313 to the particular SIM card.

6. Application Server

Turning now to FIG. 27, this figure illustrates the functional units within the application server 203. The application server 203 includes a two-way interface to the application software interface 219 embedded in the database management system 196. The application server 203 also includes an XML SOAP interface 323 to the customer services server 205, for receiving instructions to perform a restore procedure or to perform a configuration procedure.

The application server 203 also includes processors specific to the particular backup and restore applications, that is, a backup application processor effective to control the backup processing via the application interface 219 and a backup application processor 325 effective to perform backup processing in response to backup messages received via the inbound channel processor 191 and inbound data processor 193.

Finally, the application server is adapted to be programmed with further functions. Two examples are shown, that is, a predictive subscriber rating processor 329 and a fraud management system 331. These functions will be described in more detail later.

### Second Embodiment: Data Structure of the Transmitted Messages

The form of the messages transmitted between the mobile stations 1 and the data backup service centre 3 will now be described.

1. Form of Backup Message

The form of the data in the backup data message is as set out in Table 8.

TABLE 8
Backup Message

| | | | Length |
|---|---|---|---|
| Element | Mandatory? | Sub-element | (bytes) |
| PID | YES | | 1 |
| Record 1 | YES | Index into | 1 |
| | | Monitor Table | |
| | | Record number | 1 |
| | | Data | 0-137 |
| Record 2 | NO | | 2-139 |
| Record n | NO | | 2-139 |
| Checksum | YES | | 0-2 |

The backup message starts with a one byte protocol identifier (PID) which identifies the type of message

followed by one or more backup records, finishing with a variable length database checksum of up to two bytes. The checksum is calculated using the checksum field from the records in the checksum table as a 16 bit CRC value.

The first five bits of the PID identify the type of message, that is:

backup

backup acknowledgement

restore

restore acknowledgement

addressable restore

configuration

configuration acknowledgement

restore request

The remaining three bits define the length of the checksum included after the data in bytes, typically up to three bytes for a CRC checksum, but expandable in principle if a further checksum length is required. The length of the checksum is determined by the available space in the message which will depend on the bearer channel. Thus, if the bearer channel has no fixed length limitation, for example, an IP channel, or there is available space in an SMS message, the checksum will be two bytes.

2. Backup Acknowledgement Message

Table 9 indicates the typical form of the backup acknowledgement message.

TABLE 9
Backup Acknowledgement Message

| Element | Mandatory? | Sub-element | Length |
|---|---|---|---|
| PID | YES | | 1 |
| Record 1 | YES | Index into | 1 |
| | | Monitor Table | |
| | | Record number | 1 |
| | | Result | 1 |
| Record 2 | NO | | 3 |
| Record n | NO | | 3 |

The result field is a result code indicating success, temporary failure or permanent failure.

3. Restore Message

The restore message will have the configuration as set out in the following Table 10:

TABLE 10
Restore Message

| Element | Mandatory? | Sub-element | Length |
|---|---|---|---|
| PID | YES | | 1 |
| Record 1 | YES | Index into | 1 |
| | | Monitor Table | |
| | | Record number | 1 |
| | | Data | 0-137 |
| Record 2 | NO | | 2-139 |
| Record n | NO | | 2-139 |

The message starts with the protocol ID identifying the message as being a restore message. The data for each of the records to be restored then follows, the number of records actually included in the message being dependent on whether the communication channel is the short message channel or IP channel. It will be appreciated that, particularly where the short message service is being used, it may be necessary to include the data to be restored in a number of restore messages as in the previous embodiment.

4. Restore Acknowledgement Message

The restore acknowledgement message will have the form set out in the following Table 11.

TABLE 11
Restore Acknowledgement Message

| Element | Mandatory? | Sub-element | Length |
|---|---|---|---|
| PID | YES | | 1 |
| Record 1 | YES | DF | 2 |
| | | EF | 2 |
| | | Record number | 1 |
| | | Result | 2 |
| Record 2 | NO | | 7 |
| Record n | NO | | 7 |

Thus, the restore acknowledgement message identifies the type of message via the protocol ID, the file by DF and EF reference, the record(s) within the file, and whether the restore operation was successful or not.

5. Configuration Messages

The other type of message to be sent from the backup and restore service centre to the SIM card are configuration messages. Configuration messages enable the backup and restore service centre to cause the data in the SIM card to be overwritten. In particular, the configuration messages may cause the service state to be switched on or off, the backup and address system centre address to be changed, the bearer channel to be modified or the monitor table or checksum table to be rewritten or resized, the particular event being identified by a so-called “Configuration ID” (“CID”). The form of the configuration message is as set out in the following Table 12.

TABLE 12
Configuration Message

| Element | Mandatory? | Sub-element | Length |
|---|---|---|---|
| PID | YES | | 1 |
| Record 1 | YES | CID | 1 |
| | | Data | 1-20 |
| Record 2 | NO | | 2-21 |
| Record n | NO | | 2-21 |

### Second Embodiment: Opaeration of Data Backup System

1. Backup Processing

As in the first embodiment, backup and restore processing at the SIM card takes place during “idle” periods for the mobile phone. However, unlike in the previous embodiment, the polling signal interval at which the clock sends polling signals may be decreased to enable batches of restore processing to take place at closer intervals. Furthermore, the backup processing is arranged to be initiated on entry of new data via the keyboard for the phone.

Referring now again to FIG. 17(a) and (b), where a user enters new data as a new entry for the stored telephone numbers file EF_{ADN} on the phone using the keyboard, a message is sent from the SIM manager 25 to the data communication protocol unit 32 causing the file manager 34 to update the particular record stored in the EF_{ADN} files 36. As soon as the file is updated by the file manager 34, the SIM application tool kit 43 raises an event message which is sent to the backup and restore processing unit 172.

Referring now also to FIG. 28, the backup and restore processing unit 172 in response generates a status event message leading to the file update operation shown in. FIG. 28. In step S2801, the backup and restore processing unit 172 reads the file update information and in step S2802, scans the contents of the monitor table 176 stored in the backup and restore service files 173 to determine whether this information is within the range of records which must be backed up. If the corresponding file is found on the monitor table 176, the data is placed on the event queue in event buffer 181 in step S2803. Alternatively, if the data is not on the monitoring list, the process stops.

At the SIM card, as in the first embodiment, the backup and restore processing unit 172 is arranged to prioritise the status events produced by the backup and restore processing unit 172 at each incoming polling signal produced by the clock 28 in the mobile phone, in the time periods available for the SIM card processing. In particular, the SIM card deals with the following four tasks in order of priority:

(1) Sending out an outgoing message, that is a backup message, a restore message acknowledgement, a configuration message acknowledgement or an error message, previously queued in the outbound message buffer 183;

(2) Processing a file update event previously queued in the SIM card event buffer 181 following entry of new data by the phone user;

(3) Managing a restore or configuration message previously queued in the restore/configuration buffer 185; and

(4) Sending an acknowledgement message queued in the acknowledgement message buffer 184.

These events are summarised in the flow chart shown in FIG. 29 which lists the processing steps for the four events.

Where it is determined in step S2901 that there is no outgoing message pending in the outgoing message buffer 183, but it is determined in step S2902 that there is the backup event held on the event queue in the event buffer 181, the checksum table 177 stored in the backup and restore service files 173 is scanned for an element matching the monitor table index and record number in step S29013 and if the checksum is found in step S2904, it is compared to the new checksum for the updated data in step S2905 and added to an outgoing message in step S2906 in the outbound message buffer 183. Alternatively, if in step S2904 the checksum in the checksum table 177 is not found, the entry is determined to be a new entry and is added to the outgoing message stored in the outbound message buffer 183 in step S2907.

During the next polling interval, as there is now an outgoing message stored in the outbound message buffer 183, this is found in the next incidence of step S2901 and transmitted to the data backup centre via the mobile phone if and only if a retry interval has elapsed as determined in step S2908. This retry interval is set by a counter which is incremented each time a status event is received by the backup and restore processing unit 172 such as the polling signal from the clock 28 on the phone, an update file event or an incoming message. If the counter reaches a preset value, for example 5, in step S2909, the message is sent to the IP message assembler 171 or the SMS assembler 26 for transmission by the phone in step S2909. Alternatively, the counter is incremented and the process continues.

2. Reception of Data Backup Message by Backup Data Service Centre

Referring now particularly to FIGS. 19 and 23, on reception of the message which has been transmitted to the data backup service centre, either using the short message service or using the Internet, at the input interface 271 in the inbound channel processor 191(a) or 191(b), the header parser 273 recognises from the header to the incoming message, that is, the transport protocol data as shown in Table 1 as an incoming IP or SS7 data or message, whilst the payload removal unit 275 removes the data incorporated within the message. The data is then directed by the load balancer 192 to an inbound data processor 193. The inbound data processor 193 recognises from the PID at the beginning of the data message that the data is a backup message and from the index into the monitor table for the first record that the data is amongst the data which is currently being backed up, that is, the EF_{ADN} data. The mobile station ISDN number extracted from the transport protocol included in the message header is passed to the database which, via a link from the device table 237 to the user table 235, is able to identify the user ID.

The index, into the monitor table,for the first record to be read allows the monitor table 239 for the particular user to be located, the next byte in the backup data message enabling the record number within the monitor table to be identified, the data length field identifying the length of the data. The data is then read and written into the data table 243, overwriting the previous entry for that particular record. When the record is overwritten, an event is recorded in the outbound actions table 251 to acknowledge that the data record has been written. The outbound actions table records 251 that a backup data acknowledgement message should be sent, a signal being sent to an outbound data processor to trigger the backup acknowledgement message generator 324 to generate a successful backup message which is passed to the outbound channel processor 201 for return transmission to the mobile station.

3. Backup Acknowledgement Message Processing

Turning now to FIG. 30, where in step S3001 the SIM card determines from the PID that the incoming message is a backup acknowledgement message, the backup acknowledgement pointer pointing to the record to be read in the acknowledgement message buffer 184 is reset in step S3002 and the current record indicated in the backup acknowledgement message is retrieved in step S3003. Where the result field for the particular record indicates temporary failure or permanent failure, this is added to an outgoing message stored in the outbound message buffer 183 to be transmitted by the SIM card back to the data backup service centre. Where the result field indicates a successful backup operation, the pointer to the record in the backup acknowledgement message is incremented in step S3011 and it is determined whether the end of the backup message has been reached in step S3012. If there are further records to look at, the next record is then retrieved in step S3003 and steps S3004-S3007 are repeated.

4. Restore Processing

Restore processing is initiated at the backup and restore centre by the receipt of a restore request by a subscriber to the service at the customer service server 205. This is communicated to the application server 203 which sends a restore request to the application interface software 219 in the database management system 196. Within the application interface software 219, the database control language parser 227 produces a restore command which is written into the database via a request message in SQL, whilst the data translation unit 229 converts the data range specified in the incoming message to a data range retrievable from the data files 211.

Under the control of the control procedures 217 in the system global area 216, data is retrieved through the multithreaded server 215 from the user data stored in the data files 211. The application interface software is arranged to cause the data to be restored to be retrieved from the data table 243 and stored in the outbound actions table together with data derived from the user table 235 and device table 237 identifying the user and the preferred channel of communication, that is, the short message channel or the IP message channel.

Turning now also to FIG. 25, the outbound data processors 199 react to events stored in the outbound actions table 251 to extract the data for the restore message from the outbound actions table 251 to determine whether the data is to be transmitted via the short message service or via the Internet and to pass the message to the outbound message buffer 321, the message being passed via the interface 315 to an outbound channel processor 201(a) or 201(b). In the outbound channel processor 201, the message is assembled with the appropriate transport protocol in message assembler 312 and launched by message launch 313. An acknowledgement pending flag is set in the outbound actions table 251 to await the receipt of an incoming restore acknowledgement message from the mobile station.

5. Reception of Restore Message by Mobile Station

Referring now again also to FIG. 19, when the message is received by the mobile phone in the SMS reception unit or the IP message reception unit, the data in the message is extracted from the transport data protocol header and passed to the SIM card via the data communication protocol unit 32.

Referring now also to FIG. 30, receipt of a message in the inbound message buffer 182 in the SIM card prompts the process message procedure shown in this figure. In particular, in step S3001, the message type is identified as being either a restore or configuration message or a backup acknowledgement message in the protocol identifier field. If the message is identified to be a restore message, in step S3008 it is determined whether there is any action already waiting on the restore configuration buffer 185. If there is no action already pending, the incoming message is queued in the restore configuration buffer 185 in step S3009 and in step S3010, a restore flag is set. In step S3011, the poll interval of the polling signals produced by the mobile phone is reduced so as to increase the frequency at which the SIM card status events are processed and in step S3012, the contents of the acknowledgement message buffer 184 are initialized.

Turning now again to FIG. 29, assuming that in step S2901 there are determined to be no outgoing messages and in step S2902 there is determined to be nothing on the event queue, in step S2909, it will now be determined that there is something on the restore queue in the restore/configuration buffer 185. In step S2910, as it will be determined that there is a restore flag, the processing will proceed to processing of the restore queue in step S2911, which is shown in more detail in FIG. 31.

Turning now to FIG. 31, in step S3101 the first record in the incoming restore message is read and in step S3102, is compared with the contents of the monitor table 176 to determine whether the data is amongst the data which is subject to the backup and restore service. If the data is not amongst the data specified in the monitor table 176, in step S3104 an error message is generated and queued in the error message buffer 186.

Alternatively, if the data is found on the monitor table 176, the record is restored in the EF_{ADN} files 36 in step S3105. The record pointer identifying the current record to be read is incremented in step S3107.

In step S3108, it is determined whether the restore queue is empty, that is, the record pointer has reached the end of the data to be restored. If the restore queue is not empty, that is there are records remaining in the queue to be restored, the process is stopped and will be restarted when a new status event initiates the process steps of FIG. 29 assuming that there are no outgoing messages or items on the event queue. If, however, the restore queue is empty, in S3109 the data in restore queue buffer 185 and the pointer are reset and an acknowledgement flag is set in buffer 184 to acknowledge that a restore acknowledgement message must be sent to the data backup service centre.

Turning now again to FIG. 28, where in step S2812, during the process status event procedure, it is determined that there is an acknowledgement flag pending, the poll interval of pulses produced by the mobile phone is reset to the initial longer value in step S2813, a restore acknowledgement message is sent by either the short message or IP channel to the data backup service centre and in step S2815, the acknowledgement pending flag is cleared in buffer 184.

Reception of Restore Acknowledgement Message at Data Backup Service Centre

Turning now again to FIG. 19, the restore acknowledgement message is received by an inbound channel processor 191(a) or 191(b) as appropriate at the data backup service centre, recognised as a restore acknowledgement message at the inbound data processor 193 and used to clear the acknowledgement pending flag in the outbound actions table 251 in the database to indicate that the restore process has been successfully actioned at the SIM card. Alternatively, if the result filed in the restore acknowledgement message indicates that the restoration was not successfully taken place, then the flag in the outbound actions table is not reset, and the restore operation is reactioned. The restore operation may be set to repeat at decreasing frequency in the event of an unsuccessful restore operation.

Addressable Restore

A further function of the system is the so-called addressable restore which allows the backup and restore service to restore data which is not specified in the monitor table. This can, for example, be used to perform an over-the-air provisioning service. The processing of an addressable restore message is similar to that of the restore message, except that the SIM card does not interrogate the monitor table 176.

Configuration Processing

The configuration messages initiated by the application server act on information received from the customer service server 205. The relevant data in the database 195 is overwritten and an event placed on the outbound actions table 251 for action by an outbound data processor 199. This is queued in the action queue 319 until processed by the action processor 317, the configuration message being buffered in the outbound message buffer 321 until it is assembled as an outgoing message and launched by the outbound channel processor 201.

Returning now to the receipt of the configuration message by the mobile station, on reaching the SIM card the message is buffered in the inbound message buffer 181 and the event of receipt of a configuration message stored in the event buffer.

Referring now also to FIG. 30, where in step S3001 the message is determined from the PID to be a configuration message, the SIM card backup and restore processing unit 172 goes through the same procedural steps S3008 to S3012 as in restore processing other than for the setting of a restore flag in step S3010, the pending configuration flag instead being cleared.

Turning now to FIG. 29, in the absence of a pending outgoing message or anything on the event queue, as the configuration message is now on the restore/configuration queue held in the restore/configuration buffer 185, the procedure progresses to step S2916, that is, the processing of the configuration queue, this being shown in more detail in FIG. 32.

Turning now particularly to FIG. 32, the current configuration record is read in step S3201 and processed in step S3202. A configuration acknowledgement message is updated and stored in buffer 184 in step S3203 and in step S3204, the pointer pointing to the current record in the process configuration queue stored in buffer 185 is incremented. If the record now indicated is empty, the configuration queue is reset and the pointer initialised in step S3205 and in step S3206, the acknowledgement flag is set to trigger the sending of a configuration acknowledgement message back to the data backup service centre as set out in steps S2912 to S2915 in FIG. 29. If the data record is not empty, the processing stops pending further processing of the incremented pointer number record in step S2916 at the next processing stage as determined by the flowchart of FIG. 29.

### Third Embodiment: Overview

In the third embodiment to be described, the data message structures are generalised to enable different data to be backed up, the backup processing is initiated by entry of new ADN data on the keyboard of the mobile phone, and the data backup data service centre acts as a Short Message service centre. It will be appreciated, however, that each of these features may be incorporated separately in the first and second embodiments described above. The mobile station is generally as shown in FIG. 3 and described in the first embodiment. The Data Backup Service Centre is a modification of the Data Backup Service Centre in the first embodiment, as will now be described.

### Third Embodiment: Mobile Station

In the third embodiment, in a similar manner to the second embodiment, a command structure 73 may be programmed within the SIM kernel 51 to provide “prompt” signals on the entering of abbreviated dialling number data through the keyboard of the mobile phone 7 which notify the Applet forming the backup and restore processing unit 41 that APDU (Application Protocol Data Units) data for updating the EF_{ADN} file has been received from the mobile phone 7.

Referring now to FIG. 34, this figure illustrates the backup service monitor files 71 which are stored in the memory 61 of the SIM card 8 in such an alternative embodiment. In particular, the backup file 49 is substituted by a “changes to be backed up” file including a set of flags for each ADN record in the abbreviated dialling numbers file 36 indicating whether a user has input any changes to the record using the keyboard. Finally, a further file comprises a “Current Backup” file including flags for each record for indicating whether any changes have been made and have been included in the last backup data message which is currently in the buffer 38 or being transmitted by the mobile phone.

### Third Embodiment: Data/Backup Service Center

In the third embodiment, the data backup service centre 3 is arranged to act as a Short Message Service Centre located on the same site as the network operator's site, but located in an access controlled premises.

Referring now particularly to FIG. 35, in which corresponding components to those in FIG. 8 are correspondingly labelled, in order that the data backup service centre 3 can be made compatible with different network technologies, the data backup service centre 3 is divided into two sets of components:

(1) A database server 83 and associated database 85.

(2) A network adaptor 1801 comprising an SMS adaptor 81 and a signalling gateway 1803.

It will be appreciated that in practice all the above components may be constituted by software running on the same hardware, in which case the interfaces between the various components may be software components. However, in some situations it may be appropriate for the signalling gateway 1803 to be constituted by software running on a separate piece of hardware to that on which the SMS adaptor 81 is constituted. In this case, the interface between the signalling gateway 1803 and the SMS adaptor 81 may be a TCP-IP hardware interface, or alternatively a software interface.

The signalling gateway 1803 is connected via physical links, for example, coaxial cables to the SMS-Gateway Mobile Switching Centre 75 and the SMS-Interworking Mobile Switching Centre 73 so as to be effective to receive SMS signals from the SMS-Interworking Mobile Switching Centre 73 and to transmit SMS signals to the SMS-Gateway Mobile Switching Centre 75. The signals are transmitted between the public land mobile network 5 and the signalling gateway 89 using a conventional common channel signalling system 7 (SS7) which incorporates signalling protocol inserted within the network. As is conventional for data transfer El frame format SS7 signals are used, this having a maximum bit rate of 2.048 Mbps.

Turning now also to FIG. 36, this figure describes in more detail the functional components of the signalling gateway 1803 where the backup service centre 3 forms a Short Message Service Centre.

The signalling gateway 1803 includes a Short Message extractor 1804 effective to receive SS7 signals transmitted by the IWMSC 73, to terminate the SS7 signalling protocol and to produce Short Message based data for onward transmission to the SMS adaptor 81. The signalling gateway 1803 further includes a SS7 message assembler 103 effective to receive Short Messages produced by the SMS adaptor 81, add SS7 signalling protocol and transmit the SS7 signals to the SMS-Gateway Mobile Switching Centre 75 within the network 5.

### Third Embodiment: Data Structure

In the embodiments described above, each Short Message includes data for a maximum of four EF_{ADN} entries. In the third embodiment, the data structure may be more generalised to allow adaptation to backup of different data and different message lengths. Assuming that more ADN data is to be included that will fit into a single Short Message, the data will be included in a series of “Change” messages, the final set of data being included in a “Change Complete” message. The typical form of each “Change” message is shown in Table 13.

TABLE 13
Change Message

| REFERENCE | DESCRIPTION |
|---|---|
| Message ID | Parameter identifying |
| | that the message includes |
| | backup data. |
| Protocol Version ID | Parameter identifying the |
| | structure of the message. |
| Data Type | Parameter identifying the |
| | type of data, i.e. ADN |
| | data. |
| ADN data | Each set of ADN data, |
| | each set containing a tag |
| | which identifies the |
| | field of data, the length |
| | of the data in the field, |
| | and a value for the data. |

This message will be followed by a “Change Complete” Short Message including error control data typically as set out in Table 14.

TABLE 14
Change Complete Message

| REFERENCE | DESCRIPTION |
|---|---|
| Message ID | Parameter identifying |
| | that the message includes |
| | backup data. |
| Protocol Version ID | Parameter identifying the |
| | structure of the message. |
| Data Type | Parameter identifying the |
| | type of data, i.e. ADN |
| | data. |
| Check Data | Checksum over all the ADN |
| | data stored in the |
| | updated ADN files 63 in |
| | the SIM card 7. |
| ADN data | Final set of ADN data of |
| | the format described in |
| | Table 2. |

It will be appreciated that the above data is specifically indicative of backup data transmitted by the mobile station 1 through the network 5 to the data backup service centre 3.

Further messages such as error messages and control messages may also be transmitted through the system. These will, however, generally include similar transport protocol (TP) data indicated above, although the data backup service centre 3 may initiate the signal. The data format within the control messages will be as set out in Table 15.

TABLE 15
Control Message

| DESCRIPTION | CONTENT |
|---|---|
| Message ID | Parameter identifying |
| | that the message includes |
| | backup data. |
| Protocol Version ID | Parameter identifying the |
| | structure of the message. |
| Request | Type of Request. |

The type of request will include the requesting of a restore operation, or a database resynchronisation operation.

### Third Embodiment: Operation of the Data Backup System

Backup Processing

FIG. 36 illustrates various steps performed in the mobile station 1 (either by the mobile phone 7 or the SIM card 8) the public land mobile network 5 and the backup service centre 3 during successful backup of changes to the abbreviated dialling code address book by a user entering data through the keyboard of the mobile phone 5 following receipt of a “Change Complete” message by the backup service centre 3 where backup processing is instigated by “prompt” signals.

In step S1 user entry of keyboard data through the keyboard interface 27 is effective to cause the SIM manager 25 in the mobile phone 7 to produce appropriate signals (so called “application protocol data units” (APDU)) to the data communication protocol unit 32 within the SIM card 7. Through the data communication protocol unit 32, the SIM card 8 is able to identify that the data signals refer to updates in the abbreviated dialling number file, EF_{ADN}, and that records within an EF_{ADN} file are to be updated.

In step S2, in response to the data signals identified as being update signals to the EF_{AN} file, a PROMPT signal is generated in the SIM kernel 31 which is effective to initiate the backup manager 63. This sets up the flags in the “Changes to be backed up” file illustrated in FIG. 17, the first record being amended in the particular example being illustrated. Using an “OR” operation to transfer the information, the flag data in the “Changes to be backed up” file is copied into the “Current Backup Status” file such that the amendment to record 1 is added to an existing amendment to be made to record 2 and the “Changes to be made” flags are reset. The ADN data for each entry 1 and 2 is then temporarily stored in the buffer 38 within the EEPROM 35, the data being organised in each “Change” message as indicated in Table 2 to include a message ID, the modified ADN data and, in the final “Change Complete” message as indicated in Table 3 a checksum in order to enable error control to-be-performed.

The data is sent via the data communication protocol unit 32 to the mobile phone 7 for inclusion in an SMS message including the transport protocol shown in Table 1 by the SMS assembler 26. When either the total amount of possible data has been incorporated in the data field 15 shown in FIG. 2 or after a predetermined amount of time, the predetermined amount of time is compared with timing signals derived from the clock 28 within the mobile phone 7 to measure the time from which the user started entering the updated ADN data. The mobile phone is then arranged to transmit the Short Message through the antenna 9 during one or more unused time slots, further Short Messages following if necessary to incorporate all the new or updated ADN data (step S3).

Whilst the above description has described the initiation of the backup data transmission in response to the entering,of data by a user through the keyboard on the mobile phone, it being efficient to include a time delay before an SMS data backup signal is transmitted in order to incorporate as far as is possible all the changes made by the user at a particular time, other ways of initiating the backup process are possible. In particular, the timer may not be used and the transmission of data may be dependent only on the entry of a minimum number of changes. This would avoid a potential problem in some particular mobile stations in that the user may turn the mobile phone off before backup has taken place. Alternatively, the system may be arranged so as to enable the backup to take place in response to polling signals received from the data backup service centre rather than from the mobile phone.

On reception of a Short Message by the base transceiver station 67 within the public land mobile network 5, the mobile switching centre 71 in the network 5 will derive the address of the backup data service centre and route the signal bearing the Short Message to the appropriate SMS-Interworking Mobile Switching Centre 73. The SMS-Interworking Mobile Switching Centre 73 is effective to incorporate the incoming Short Message in appropriate SS7 transport protocol and to transmit the resultant SS7 signal to the signalling gateway 89 within the data backup service centre 3 (step S4).

In step S5, the SS7 message extractor 101 of the signalling gateway 1803 is effective to remove the SS7 protocol, and transfer data representative of the Short Message to the SMS adaptor 81.

25 The backup data extractor 109 extracts the ADN data from the backup data 15 within the Short Message together with an indication of the ISDN number for the particular mobile station, thus identifying the particular mobile station account holder and sends this data to the database server 83 (step S6).

The database server is effective to check the ISDN number of the mobile station from which the Short Message has originated against the account information held in the database 85 to determine whether the user of the mobile station has actually subscribed to the data backup service. Assuming that this is the case, the data for the particular user is identified within the database 85 and it is determined using the ADN record number whether the received ADN data is a modification to existing records within the database or whether the data is new data. The records in the database 85 are accordingly either overwritten or newly entered (step S7). The data could of course be identified in some other way than by the ADN record number.

On receipt of the final “Change Complete” message, the checksum processor 121 performs a checksum analysis over all the data now stored in the database 85 and checks this against the checksum for the ADN data stored in the SIM card as included in the “Change Complete” message to ensure that the backed up ADN data replicates the stored data in the SIM card (step S8).

At this point a notification that successful data backup has taken place is sent to the data originating mobile station 1 via the SS7 message assembler 103 and the network 5 (steps S9 and S10).

On acknowledgement of a successful backup operation, the flags in the “Current Backup File” in the backup files 71 are then reset.

In the absence of an appropriate confirmation that the backup has successfully taken place or the reception of an error message, the flags in the “Current Backup” file provide a further safeguard for retrieval of data which must be backed up. As the flags in the “Current Backup” file are not reset until receipt of a positive confirmation that successful backup confirmation has taken place, backup data corresponding to entries in respect of which no confirmation has been received is then automatically included within the backup data message next time a user initiates the use of the backup system by entry of address data amendments through the keyboard.

It will be appreciated that whilst a checksum arrangement has been described to give some protection against faulty data transmission, other forms of error detection may be used.

### Other Uses of the Backup System

It will be appreciated that the above backup and restore systems give the possibility of providing further functionality to the mobile station 1 either in addition, or as an alternative, to the backup of data.

1. Itemised Billing

The storage of the backup data at the backup service centre 3 enables the possibility of itemised billing as indicated in the bill shown in FIG. 37. As the database 85 at the backup service centre 3 includes complete abbreviated dialling number files, this may be accessed by the billing system processor 95 such that numbers phoned by the mobile station 1 such as that of “BOB” may be identified on the bill. Where this number is pre-registered as a preferred number, this may then appear with a discount on the bill.

2. “Block” Downloading of Data

It will also be appreciated that the data stored in the backup centre may be used to enter a series of abbreviated dialling numbers, or other data, to a number of different mobile stations. This may be particularly useful in the downloading of a company address book.

3. Predictive Subscriber Rating

Referring now again to FIG. 28, the predictive subscriber rating processor 329 is designed to give each user a rating dependent on the user's predicted usage of their mobile phone even when a new user has no call history. This rating will be used by customer services for the phone network to ensure that users having a high rating have priority treatment when they contact customer services.

The predictive subscriber rating processor relies on the assumption that most subscribers to a telephone service enter numbers into their phonebook before making calls, or after the first call, incoming or outgoing, to each number. Thus, by interrogating the Data Backup Service Centre database to determine the number of entries each user has in their EF_{ADN} file, it is possible for the predictive subscriber rating processor to give each user a rating dependent on their predicted usage of their phone.

4. Fraud Management System

With regard to the fraud management system 331, this system is designed to identify possible fraudulent use of a phone.

Known systems for identifying potentially fraudulent use rely on detecting frequent high cost calls of long duration to premium numbers or particular international destinations using rules and pattern matching. There is a problem with such systems that pattern matching can only occur after several high cost calls have already been made. Furthermore, there is the possibility that such usage may not be made fraudulently, but is made by a genuine user making genuine long distance calls. By use of the data in the data backup service database, it is possible for a fraud management system to interrogate the database in order to isolate possible fraudulent use of a phone. In particular, the following information can be obtained from the database:

(1) Total number of stored phonebook entries;

(2) Frequency of phonebook changes;

(3) Phonebook entries with no matching outgoing or incoming calls; and

(4) A complete phonebook including names, numbers and EF_{ADN} records.

The following rules can then be applied from this information to determine possible fraudulent use from a particular mobile station:

(1) High call volume, but few or no phonebook entries;

(2) If there are any phonebook entries, whether there have been any changes since the original update;

(3) If there are any phonebook entries, whether few if any of them are outgoing or incoming calls; and

(4) Whether the stored phonebook matches a previously stored fraudster's pattern of user.

It has been found that some fraudulent users tend to make calls to the same destination numbers at the same time of day-from-the same mobile phone cell locations. Where a fraudulent user has been identified, their phonebook and usage pattern can be stored enabling the fraud management service to identify further fraudulent use, even before it happens. Such usage patterns would be stored by a third party fraud management system.

If no usage patterns are stored, a usage pattern test can still be run through the data backup service database using the usage pattern of a previous fraudulent user.

It will be appreciated that, whilst the fraud management system 331 is shown within the application server 203, where the fraud management system is run by a third party to the system operator for the backup and restore service, the fraud management system may run on a separate server.

It will also be appreciated that whilst the invention is particularly appropriate to the backup of abbreviated dialling number data on a SIM card in a mobile phone, the invention may also be used to backup other data, particularly on a number of mobile stations. This may be other data stored on either the SIM card or within the mobile phone within a mobile station. Alternatively, the data backup/restore service may be used to backup and restore other data, for example within a personal computer or a personal data apparatus.

1-54 cancel

55. A data storage system for use in a data backup system for backing up in a remote database system, data stored in a plurality of data storage systems, the data storage system comprising:
a data updating system operative to update data stored in the data storage system;
a data message producing system operative to produce a data message including a copy of the updated data; and
a wireless transmission system operative to wirelessly transmit said copied data to said remote data storage system for storage.

56. A system according to claim 55 in which the data storage system is a storage means in a mobile station.

57. A system according to claim 56 in which the storage means is a memory in a Subscriber Identity Module card for a mobile phone.

58. A system according to claim 56 in which the data is abbreviated dialling code data.

59. A system according to claim 55 in which the updating system and wireless transmission system are arranged to automatically wirelessly transmit said updated data to the database system on update of the data in the data storage system.

60. A system according to claim 59 including:
a storage system storing a flag in respect of each set of data for indicating which sets of data in the data storage system have been updated since updated data was last transmitted; and
the data message producing system being operative to insert updated data in a data message to be transmitted.

61. A system according to claim 60 including a processor operative:
to periodically calculate a checksum for each set of data stored in the data storage system; and
to compare the calculated checksum with a stored checksum for the set of data;
wherein each said flag is indicative of whether the checksum and stored checksum are the same.

62. A system according to claim 59 including a processor operative:
to periodically calculate a checksum for each set of data stored in the data storage system; and
to compare the calculated checksum with a stored checksum for the set of data;
wherein each said flag is indicative of whether the checksum and stored checksum are the same, in which the calculating of checksums for each set of data is performed sequentially in a series of time slots when the mobile station is in an Aidle@ mode.

63. A system according to claim 55 in which the data is transmitted in a series of data messages.

64. A system according to claim 55 in which said wireless transmission system is operative to generate a Short Message Service message including the updated data for transmission to the remote database system.

65. A system according to claim 55 in which said wireless transmission system includes an arrangement operative to generate a signal including data for transmission via the Internet.

66. A system according to claim 55, including a system for receiving restore data wirelessly transmitted to the data storage system from the remote database system, and storing said restore data in said data storage system.

67. A system according to claim 66 in which said system for receiving is operative to receive short message service messages including said restore data.

68. A system according to claim 66 in which said system for receiving comprises means operative to receive a message transmitted by the Internet including said restore data.

69. A database system for use in a database backup system for backing up at a database system data stored in a plurality of data storage systems remote from the database system comprising:
a reception arrangement operative to receive data wirelessly transmitted from each of the plurality of remote data storage systems on update of the information stored in each data storage system; and
a storage arrangement operative to store said received data.

70. A database system according to claim 69, including a wireless transmission system operative to wirelessly transmit a message to the remote data storage system to indicate that successful storage of said received data has taken place.

71. A database system according to claim 69, wherein said reception arrangement enables data transmitted by different modes to be received.

72. A database system according to claim 69, including a wireless transmission system which wirelessly transmits restore data to one of said remote data storage systems based on said stored received data.

73. A database system according to claim 72, wherein the preferred transmission mode of each remote data storage means is stored.

74. A database system according to claim 72, wherein said wireless transmission system assembles Short Message Service Messages including said restore data, and transmits said short message service messages.

75. A database system according to claim 69, storing data relating to the configuration settings for each remote data storage system, messages being wirelessly transmitted to a selected remote data storage means to change the configuration setting for the selected remote data storage system.

76. A database system according to claim 69, wherein the remote database is included in a mobile station, said data relates to dialling numbers stored in the remote database, the database system being operative to provide information relating to the dialling numbers to a billing system.

77. A database system according to claim 69, in which fraudulent use of a remote data storage means based on the data stored in the database system is identified.

78. A database system according to claim 69, in which future usage of a remote data storage means based on the data stored in the database system is predicted.

79. A database system according to claim 69 in which the same data is wirelessly transmitted to a plurality of said remote storage systems.

80. A data storage method for backing up in a remote database system, data stored in a plurality of data storage systems, comprising:
updating data stored in the data storage system;
producing a data message including a copy of the updated data; and
wirelessly transmitting said copied data to said remote data storage system for storage.

81. A method according to claim 80 in which the data storage system is a storage means in a mobile station.

82. A method according to claim 81 in which the storage means is a memory in a Subscriber Identity Module card for a mobile phone.

83. A method according to claim 80 in which the data is abbreviated dialling code data.

84. A method according to claim 80 including automatically wirelessly transmitting said updated data to the database system on update of the data in the data storage system.

85. A method according to claim 84 including:
setting a flag in respect of each set of data for indicating which sets of data in the data storage system have been updated since updated data was last transmitted; and
inserting updated data in a data message to be transmitted dependent on the setting of said flag.

86. A method according to claim 85 including periodically calculating a checksum for each set of data stored in the data storage system; and
comparing the calculated checksum with a stored checksum for the set of data; and
wherein each said flag is indicative of whether the checksum and stored checksum are the same.

87. A method according to claim 86 in which the calculating of checksums for each set of data is performed sequentially in a series of time slots when the mobile station is in an Aidle@ mode.

88. A method according to claim 80 in which the data is transmitted in a series of data messages.

89. A method according to claim 80 comprising generating a Short Message Service message including the updated data for transmission to the remote database system.

90. A method according to claim 80 comprising generating a signal including data for transmission via the Internet.

91. A method according to claim 80 including receiving restore data wirelessly transmitted to the data storage system from the remote database system, and storing said restore data in said data storage system.

92. A method according to claim 91 in which a short message service message including said restore data is received.

93. A method according to claim 91 in which a message transmitted by the Internet including said restore data is received.

94. A method of backing up at a database system data stored in a plurality of data storage systems remote from the database system comprising:
receiving data wirelessly transmitted from each of the plurality of remote data storage systems on update of the information stored in each data storage system; and
storing said received data.

95. A method according to claim 94 including wirelessly transmitting a message to the remote data storage system to indicate that successful storage of said received data has taken place.

96. A method according to claim 94 wherein data transmitted by different transmission modes may be received.

97. A method according to claim 94 including wirelessly transmitting restore data to one of said remote data storage systems based on said stored received data.

98. A method according to claim 94 including storing the preferred transmission mode of each remote data storage means.

99. A method according to claim 97 including assembling of Short Message Service Messages including said restore data, and transmitting said short message service messages.

100. A method according to claim 94 including storing data relating to the configuration settings for each remote data storage means; and
wirelessly transmitting messages to a selected remote data storage means to change the configuration setting for the selected remote data storage means.

101. A method according to claim 94 wherein the remote database is included in a mobile station, said data relates to dialling numbers stored in the remote database, the database system being arranged to provide information relating to the dialling numbers to a billing system.

102. A method according to claim 80 including identifying fraudulent use of a remote data storage means based on the data stored in the database system.

103. A method according to claim 80 including performing prediction of future usage of a remote data storage means based on the data stored in the database system.

104. A method according to claim 80 comprising wirelessly transmitting the same data to a plurality of said remote storage systems.

105. A data backup system including a plurality of data storage systems each according to claim 55 and a database system according to claim 69.

106. A signal for use in a data backup system according to claim 105 including:
data for identifying one of said data storage systems and the remote database;
data representative of data stored in the data storage system; and
data identifying the operation to be performed by whichever of the database system and the data storage means is to receive the data.

107. A computer program including processor implementable steps for performing a method according to claim 80.

108. A data backup system for use in a subscriber module in a mobile phone, the data backup system enabling the backing up, in a remote data storage system, of data entered in a user updateable database in the subscriber module, the remote storage system being arranged to back up data from a plurality of said data backup systems, the data backup system comprising:
an arrangement operative to determine that the data in the updateable database has been updated;
a data message producing system operative to produce a data message including a copy of the updated data;
a data backup system operative to cause the mobile phone to transmit automatically and wirelessly said data messages to said remote data storage system after update of said data;
a data reception arrangement operative to receive from said remote database system wirelessly transmitted messages including copies of data stored in said remote database system forming restore data for the updateable database, the updateable database being operative to store said restore data;
a scheduler operative to prioritise pending operations to select one operation, the operations comprising: determining whether said updateable database has been updated, producing said data messages including a copy of the updated data, transmitting said data messages to the remote data storage system, receiving messages from the remote database system and storing received restore data in the updateable database in order to select one operation; and
said one operation being performed during one or more time slots when the mobile phone is otherwise inactive.

109. A system according to claim 108 in which said time slots are defined by polling signals received by the subscriber module from the mobile phone.

110. A data storage system for use in a data backup system for backing up in a remote database system, data stored in a plurality of data storage systems, the data storage system comprising:
a data updating system operative to update data stored in the data storage system, the data storage system also storing a monitor table specifying which data is to be backed up;
a data message producing system operative to produce a data message including a copy of the updated data specified in the monitor table; and
a wireless transmission system operative to wirelessly transmit said copied data to said remote data storage system for storage.
